(19) United States
(12) Patent Application Publication
(10) Pub. No.: US 2016/0114626 A1
(43) Pub. Date: Apr. 28, 2016

(54) HANDLE ASSEMBLY FOR AN AXLE

(71) Applicant: RAPHAEL SCHLANGER, WILTON, CT (US)

(72) Inventor: RAPHAEL SCHLANGER, WILTON, CT (US)

(21) Appl. No.: 14/974,228

(22) Filed: Dec. 18, 2015

Related U.S. Application Data
(63) Continuation-in-part of application No. 14/958,263, filed on Dec. 3, 2015.
Application No. 14/958,263 is a continuation-in-part of application No. 14/952,645, filed on Nov. 25, 2015.
Application No. 14/952,645 is a continuation-in-part of application No. 14/602,543, filed on Jan. 22, 2015.
Application No. 14/602,543 is a continuation-in-part of application No. 13/914,490, filed on Jun. 10, 2013.
Application No. 13/914,490 is a continuation-in-part of application No. 12/655,433, filed on Dec. 30, 2009, now Pat. No. 8,485,335.
(60) Provisional application No. 62/124,391, filed on Dec. 18, 2014.
(60) Provisional application No. 62/124,391, filed on Dec. 18, 2014.
(60) Provisional application No. 61/965,201, filed on Jan. 27, 2014.

(51) Int. Cl. B60B 27/02

(52) U.S. Cl. CPC B60B 27/026; B62K 2025/025

(57) ABSTRACT

A vehicle wheel axle assembly, including: an axle element that is rotationally stationary about an axial axis; a handle connected to the axle element that may be pivotally articulated relative to the axle element about a pivot axis and between an open position and a closed position; and a frame element with a first frame member to interface with the axle assembly. The handle includes a handle axis extending in a direction generally perpendicular to the pivot axis, a radially projecting lever portion, and a lever axis extending radially outwardly from the pivot axis and along the lever portion. The pivot axis is generally parallel to the lever axis. The axle assembly is secured to the first frame member by means of a threadable engagement. With the handle in the open position, the axle element may be manually manipulated by means of the handle to threadably adjust the threadable engagement.

### CROSS-REFERENCE TO RELATED APPLICATIONS

This application claims priority of U.S. Provisional Patent Application 62/124,391, filed Dec. 18, 2014 and entitled “VEHICLE HUB ASSEMBLY”.

This application is also a Continuation-In-Part of U.S. patent application Ser. No. 14/958,263, filed Dec. 3, 2015, which is currently pending, and which claimed priority of U.S. Provisional Patent Application 62/124,391, filed Dec. 18, 2014 and entitled “VEHICLE HUB ASSEMBLY”.

U.S. patent application Ser. No. 14/958,263 is also a Continuation-In-Part of U.S. patent application Ser. No. 14/952,645 filed Nov. 25, 2015 and entitled “VEHICLE WHEEL AXLE ASSEMBLY”, which is currently pending, and which claimed priority of U.S. Provisional Patent Application 62/124,391, filed Dec. 18, 2014 and entitled “VEHICLE HUB ASSEMBLY”.

U.S. patent application Ser. No. 14/952,645 is also a Continuation-In-Part of U.S. patent application Ser. No. 14/602,543 filed Jan. 22, 2015 and entitled VEHICLE WHEEL AXLE ASSEMBLY, which is currently pending, and which claimed priority of U.S. Provisional Patent Application 61/965,201 filed Jan. 27, 2014, which has since expired.

U.S. patent application Ser. No. 14/602,543 is also a Continuation-In-Part of U.S. patent application Ser. No. 13/914,490 filed Jun. 10, 2013 and entitled VEHICLE WHEEL HUB ASSEMBLY, which is currently pending, and which is a Continuation-In-Part of U.S. patent application Ser. No. 12/655,433 filed Dec. 30, 2009 and entitled TORQUE COUPLING ASSEMBLY, which is currently issued as U.S. Pat. No. 8,485,335.

U.S. Pat. No. 8,485,335 claimed priority of U.S. Provisional Patent Application 61/204,130 filed Jan. 2, 2009, which has since expired.

### BACKGROUND

1. Field of the Invention

The present invention relates to a vehicle wheel axle assembly, particularly including a folding handle connected to the handle, where the handle provides a means for manual manipulation of the axle assembly. More specifically, the handle may be articulated and/or pivotably folded between an open or extended position to facilitate the manual manipulation of the axle assembly and a closed or collapsed position for lower profile and increased aerodynamics.

2. Discussion of Prior Art

Heretofore, the prior art mechanisms for the attachment and connection of bicycle wheels to the bicycle frame and/or fork has included two basic categories: the quick release skewer and the through-axle.

It is highly desirable to be able to install and uninstall the bicycle wheel to the frame very quickly and easily. Particularly in bicycle racing conditions, when every second counts, the ability to quickly swap out wheels (in the case of a flat tire, for instance) is critical. Reducing the time required to install and uninstall the wheel may result in the margin of difference between winning and losing the race.

It is also highly desirable that the system for wheel attachment be simple and intuitive to operate. The user must be able to learn its operation with a minimum of instruction. Further, this operation should not be overly complex or require a significant level of skill on the part of the operator.

The quick-release skewer system commonly utilizes a single-arm lever that extends along a lever axis and that pivots about a pivot axis at the end of the skewer shaft. The pivot axis is perpendicular to the lever axis. This lever is not particularly designed for twisting the skewer shaft about the axial axis. Instead, it is designed to pivot about the pivot axis to activate a cam that serves to shorten the skewer shaft along the axial axis. As such, this design does not provide an effective means twisting or rotating the skewer shaft about the axial axis. Further, since the pivot axis is perpendicular to the lever axis, pushing or pulling the lever in the axial direction serves simply to flex the pivot and is not effective at controlling and/or manipulating the axial displacement of the skewer shaft. Further, even if one desired to utilize this single-arm lever to apply torque to the shaft, it is only a single arm and must extend a great radial distance in order to provide the leverage required to manually torque the shaft.

With the advent of mountain bikes, and with the desire to have a more robust and stiff wheel attachment system, the through-axle has been utilized as a heavier-duty wheel attachment system to replace the quick-release skewer system. This through-axle system is similar to that used on motorcycles and has a separate axle element that is passed axially through the dropouts of the frame and through the axle sleeve of the wheel. The through-axle commonly threads directly into the frame or fork of the bicycle. A hex key or wrench is commonly engaged to mating geometry of the through-axle shaft to manually twist the shaft and tighten the threaded engagement between the shaft and the frame. This hex key or wrench is now an additional separate component that the operator must keep track of and must store. Also, taking care to connect the hex key or wrench to the shaft adds precious seconds when installing or removing the wheel to/from the frame.

In some instances, a single-arm, similar to the lever for a quick-release skewer, may be incorporated into the through-axle shaft. However, in this case, the lever is utilized to activate a cam that serves to shorten the skewer shaft along the axial axis and is not designed to provide a high level of twisting torque or to facilitate axial manipulation of the shaft. The resulting shortcomings of this lever design are similar to those of the quick-release skewer system, as described above.

### SUMMARY OF THE INVENTION—OBJECTS AND ADVANTAGES

In accordance with the present invention, it has now been found that the forgoing objects and advantages may be readily obtained.

It is an object of the invention to provide a handle for an axle assembly that may be easily manipulated to install and/or uninstall the wheel to/from the frame to which it is mounted. This handle must provide a highly effective user interface to facilitate manual manipulation and twisting to effect significant torque on the shaft to provide threadable tightening about the axial axis. Further, this handle should also be highly effective user interface to facilitate the control and manual manipulation of the axial displacement of the shaft as well. Finally, it is an object of the invention to easily articulate the handle so that it has a lower profile and reduced axial projection when it is not being manipulated. This provides enhanced aesthetics and improved aerodynamics of the bicycle.

In contrast to the prior art levers where the lever axis is perpendicular to the pivot axis, the present invention utilizes an articulating handle connected to a control shaft where the lever axis is generally parallel to the pivot axis. This provides numerous advantages over the prior art arrangement. Firstly, this allows the lever portion of the handle to include two opposed lever arms, which allow the user to create a torque couple to manually torque and twist the shaft. Thus, in comparison to a single-arm design, the amount of torque may be doubled to increase the threadable tightening torque of the shaft to the frame (in through-axle arrangements). Similarly, it allows the radial extension of the lever arms to be reduced, resulting in a more compact and aesthetically pleasing design.

Secondly, with the lever axis generally perpendicular to the pivot axis, axially pushing or pulling the handle will not induce the handle to pivot about its pivot axis. This allows the user to more easily manipulate and shuttle the control shaft in the axial direction and provides much better user control over the axial position of the shaft. This greatly enhances the user experience when axially shuttling the control shaft to install and/or remove the wheel to/from the frame.

Thirdly, after the wheel is installed and/or removed to/from the frame, the handle may be articulated and pivotally folded to reduce the axial projection of the handle and to provide a compact and lower profile appearance for enhanced aesthetics.

Fourthly, the handle tends to have an ergonomic shape that allows the operator to manually grip the handle to manipulate the shaft in the axial direction and or the rotational or circumferential direction. For example, the handle may include a radially extending lever portion that allows the user to hook their fingers around the lever portion to control the axial displacement of the shaft. Alternatively, the user may pinch the lever with their fingers to control the axial displacement of the shaft. Alternatively, the handle may include a loop such that the operator may hook their finger through the loop. With the pivot axis generally parallel to the lever axis, the manipulation just described will not tend to fold, flop, or collapse the handle.

Further objects and advantages of my invention will become apparent from considering the drawings and ensuing description.

### BRIEF DESCRIPTION OF THE DRAWINGS

The present invention will be more readily understandable from a consideration of the accompanying drawings, wherein:

FIG. 1 is a perspective view schematically illustrating the general configuration of a prior art vehicle wheel as applied to a bicycle wheel;

FIG. 2a is an exploded perspective view of a first embodiment of the present invention, showing the dropouts of the bicycle frame and a hub assembly, including a control shaft assembly;

FIG. 2b is an axial cross-sectional view taken along 51-51 of the hub assembly of the embodiment of FIG. 2a, with the control shaft axially retained with the sleeve and positioned in the axially retracted position;

FIGS. 2c-f are perspective views of the embodiment of FIG. 2a, showing the progressive sequential assembly steps involved in assembling the hub assembly to the dropouts;

FIG. 2c shows the adapter and nut assembled to one dropout and the hub assembly axially aligned in preparation for assembly with the dropouts, and with the control shaft in the retracted position;

FIG. 2d shows the hub assembly positioned between the dropouts, with each axlecap radially nested within its respective adapter and slot, and with the control shaft still in the retracted position;

FIG. 2e shows the hub assembly positioned between the dropouts, with the control shaft axially extended and threadably engaged with the adapter in the engaged position to secure the hub assembly to the dropouts;

FIG. 2f shows the hub assembly as positioned in FIG. 2e, with the handle pivotally folded;

FIGS. 2g-i are axial cross-sectional views taken along 51-51 of the embodiment of FIG. 2a, showing the progressive sequential steps involved in assembling the hub assembly to the dropouts;

FIG. 2g shows the hub assembly positioned between the dropouts, with the control shaft axially retained in the retracted position, corresponding to the assembly sequence described in FIG. 2d;

FIG. 2h shows the hub assembly positioned between the dropouts, with the control shaft in the pre-engaged position such that it is axially released and advanced toward the extended orientation, corresponding to an intermediate assembly sequence between FIGS. 2d and 2e;

FIG. 2i shows the hub assembly positioned between the dropouts, with the control shaft in an engaged position such that it is axially extended and threadably engaged with the dropout adapter, and with the handle pivotally folded, corresponding to the assembly sequence described in FIG. 2f;

FIG. 2j is a perspective view of an alternate (left) dropout corresponding to the view of FIG. 2a, where the adapter and nut are eliminated in favor of an alternate dropout configuration that includes geometry otherwise associated with the adapter, including the alignment surface and internally threaded hole;

FIG. 2k is a perspective view of the right dropout of the embodiment of FIG. 2a, detailing the open keyhole dropout slot;

FIG. 2L is a partial cross section view of the embodiment of FIG. 2a, taken along 145-145, detailing the interaction between the control shaft and the right dropout, and corresponding to the transition between the assembly sequence of FIG. 2c and the assembly sequence of 2d (and 2g), with the shank portion of the control shaft passing within the necked entrance region of the keyhole slot;

FIG. 2m is a partial cross section view of the embodiment of FIG. 2a, taken along 146-146, corresponding to the assembly sequence of FIG. 2e, FIG. 2f, FIG. 2h, and FIG. 2i, with the control shaft axially advanced toward the engagement position such that the stepped portion is positioned within the pilot region of the keyhole slot;

FIG. 3a is an exploded axial cross section view of a second embodiment of the present invention, showing the dropouts of the bicycle frame and a hub assembly, including a conventional through-axle type control shaft assembly prior to its assembly to the hub assembly and dropouts;

FIG. 3b is a perspective view of the right dropout of the embodiment of FIG. 3a;

FIG. 3c is an axial cross section view of the embodiment of FIG. 3a, showing the hub assembly positioned between the dropouts and the control shaft in position to assemble the hub assembly to the dropouts;

FIGS. 4a-e are partial perspective views of the control shaft and handle of the embodiment of FIGS. 2a-m;

FIG. 4a is an exploded view showing how the handle is to be assembled to the control shaft with a pivot pin;

FIG. 4b shows the handle assembled to the control shaft with the pivot pin;

FIG. 4c shows the handle of FIG. 4b as articulated and pivoted in the first direction;

FIG. 4d shows the handle of FIG. 4b as articulated and pivoted in the second direction;

FIG. 4e is identical to FIG. 4b and details the geometry and arrangement of the handle relative to the pivot pin;

FIGS. 5a-c are perspective views of a prior art conventional quick release skewer assembly;

FIGS. 6a-c are partial perspective views of a third embodiment of the present invention, where the handle includes a cam surface that serves to displace a follower washer to provide axial clamping of the right dropout;

FIG. 6a is an exploded view showing how the handle is to be assembled to the control shaft with a pivot pin;

FIG. 6b shows the handle assembled to the control shaft with the pivot pin, including the follower washer;

FIG. 6c shows the handle of FIG. 6b as articulated, closed, and pivoted in the first direction such that the cam surface presses the follower washer in an axially inboard direction;

FIG. 6d is a partial orthogonal view of the embodiment of 6a-c, corresponding to the open position described in FIG. 6b and detailing the cam geometry of the handle;

FIG. 6e is a partial orthogonal view of the embodiment of 6a-c, corresponding to the closed position of the handle described in FIG. 6c and detailing the cam geometry of the handle;

FIGS. 7a-c are partial perspective views of a fourth embodiment of the present invention, where the head portion is a separate element from the control shaft and includes internal threads to threadably mate with external threads of the control shaft;

FIG. 7a is an exploded view showing how the handle is to be assembled to the head portion with two shoulder bolts, and how the head portion is to be assembled to the control shaft;

FIG. 7b shows the handle assembled to the head portion via the shoulder bolts, and the internal threads of the head portion threadably mated to the external threads of the control shaft;

FIG. 7c shows the handle of FIG. 7b as articulated, closed, and pivoted in the first direction to reduce the axially outward projection of the control shaft assembly.

### DETAILED DESCRIPTION OF THE INVENTION

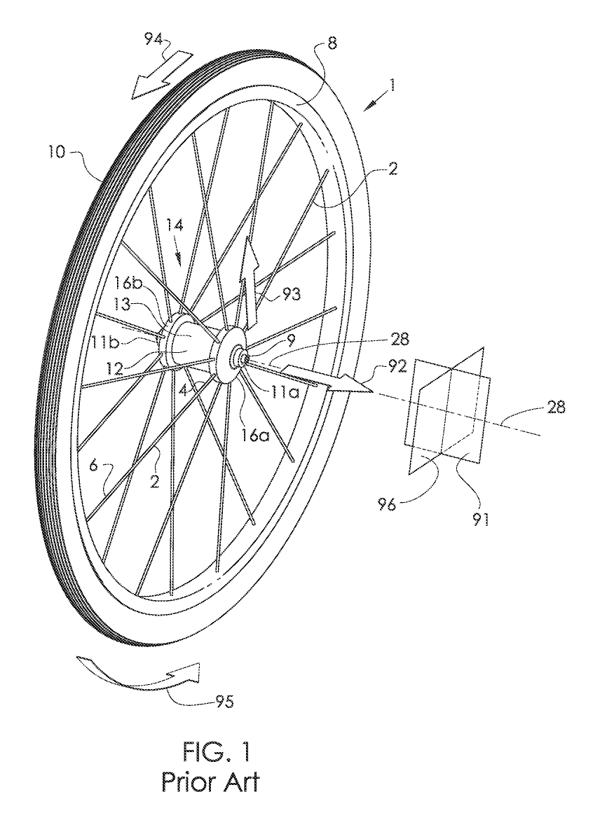

FIG. 1 describes the basic configuration of an exemplary prior art vehicle wheel, in particular, a bicycle wheel 1, as well as a description of the direction conventions used throughout this disclosure. The hub assembly 14 includes a rotatable hub shell 12 and a stationary axle 9, with bearings (not shown) to facilitate rotation of the hub shell 12 about the axial axis 28. The hub shell 12 includes a hub body 13 with at least two axially spaced hub flanges 22a and 22b, each of which include a means for connecting with the spokes (not shown). The axle 9 includes end faces 11a and 11b to interface with the dropouts (not shown). The axial axis 28 is the axial centerline of rotation of the bicycle wheel 1. The hub flanges 22a and 22b may be contiguous with the hub shell 12 or may be separately formed and assembled to the hub body 13 portion of the hub shell 12. The spokes 2 are affixed to the hub flanges 22a or 22b at their first end 4 and extend to attach the rim 8 at their second end 6. The tire 10 is fitted to the outer periphery of the rim 8. The wheel of FIG. 1 is generic and may be of tension-spoke or compression-spoke design.

The axial direction 92 is a direction parallel with the axial axis 28. The radial direction 93 is a direction generally perpendicular to the axial direction 92 and extending generally from the axial axis 28 radially outwardly toward the rim 8. The tangential direction 94 is a direction perpendicular to both the radial direction 93 and axial direction 92, defining a generally tangent vector at a given radius. The circumferential direction 95 is a cylindrical vector that wraps around the axial axis 28 at a given radius. A radial plane 96 is a plane perpendicular to the axial axis 28 that extends in a generally radial direction at a given axial intercept. An axial plane 91 is a plane that is generally parallel to the axial axis.

In the ensuing descriptions, the term “axial” refers to a direction parallel to the centerline of the axial axis and the term “radial” refers to a direction perpendicular to the axial axis. An axially inboard (or inward) orientation is an orientation that is axially proximal to the axial midpoint between the two end faces 11a and 11b. Conversely, an axially outboard (or outward) orientation is an orientation that is axially distal to the axial midpoint between the two end faces 11a and 11b. A radially inboard (or inward) orientation is an orientation that is radially proximal to the axial axis 28 and a radially outboard (or outward) orientation is an orientation that is radially distal to the axial axis 28. An axially inboard (or inward) facing surface is a surface that faces toward the axial midpoint between the two end faces 11a and 11b. Conversely, an axially outboard (or outward) facing surface is a surface that faces away from the axial midpoint between the two end faces 11a and 11b.

While it is most common for the hub shell 12 to rotate about a fixed axle 9, there are some cases where it is desirable to permit the axle 9 to be fixed with the wheel 1 such as the case where the wheel 1 is driven by the axle 9.

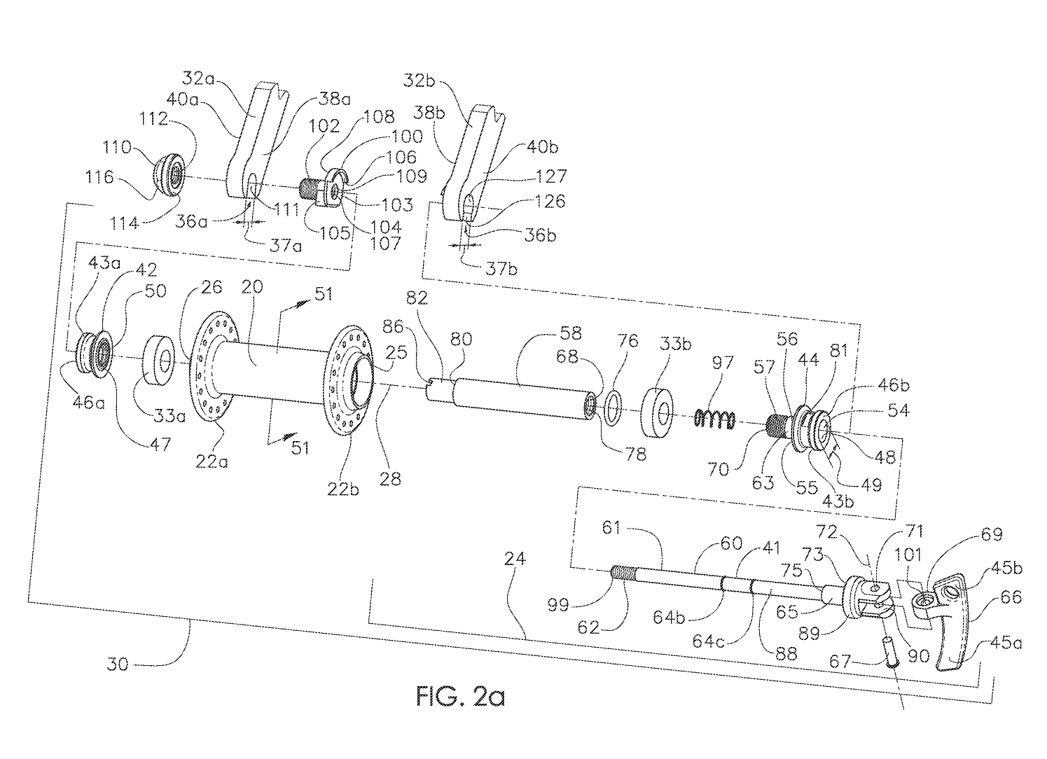

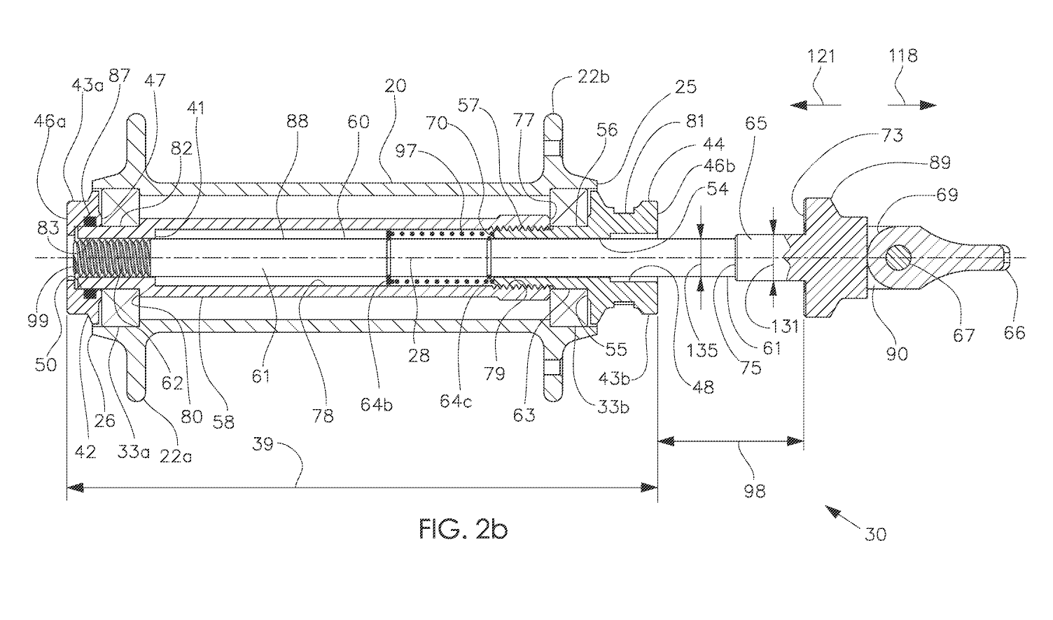

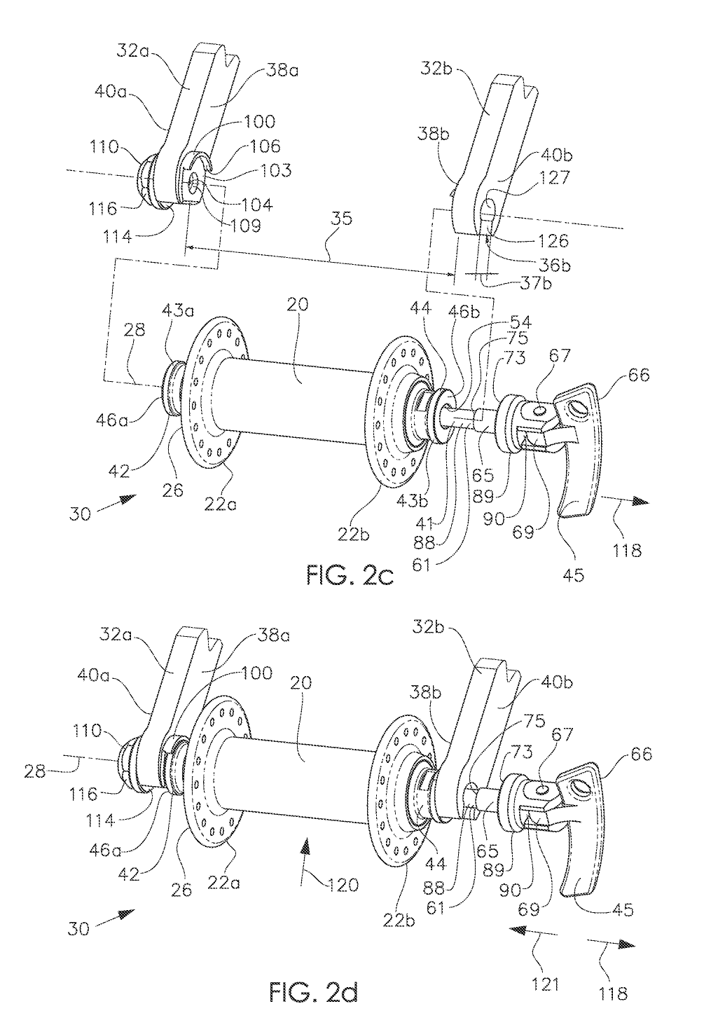

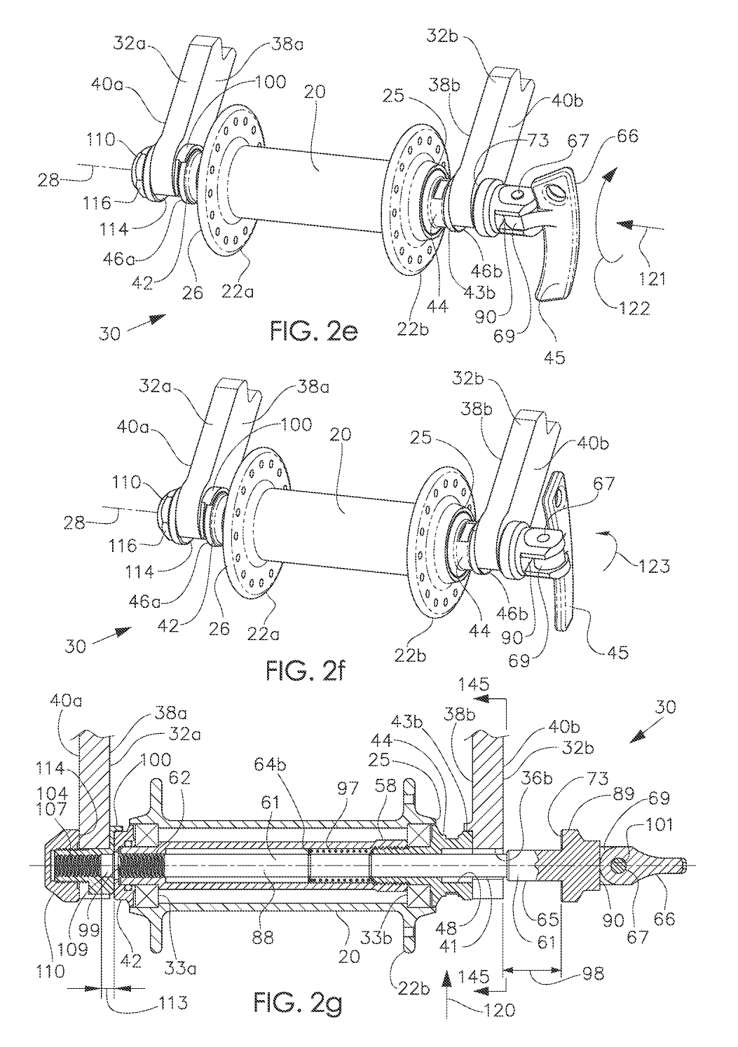

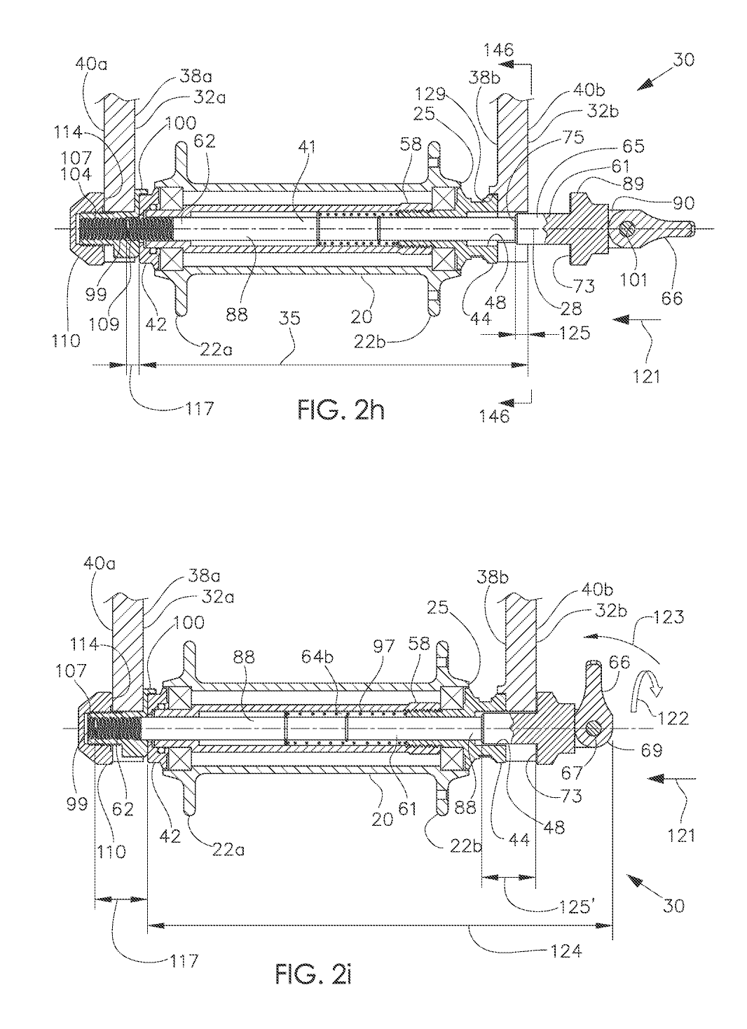

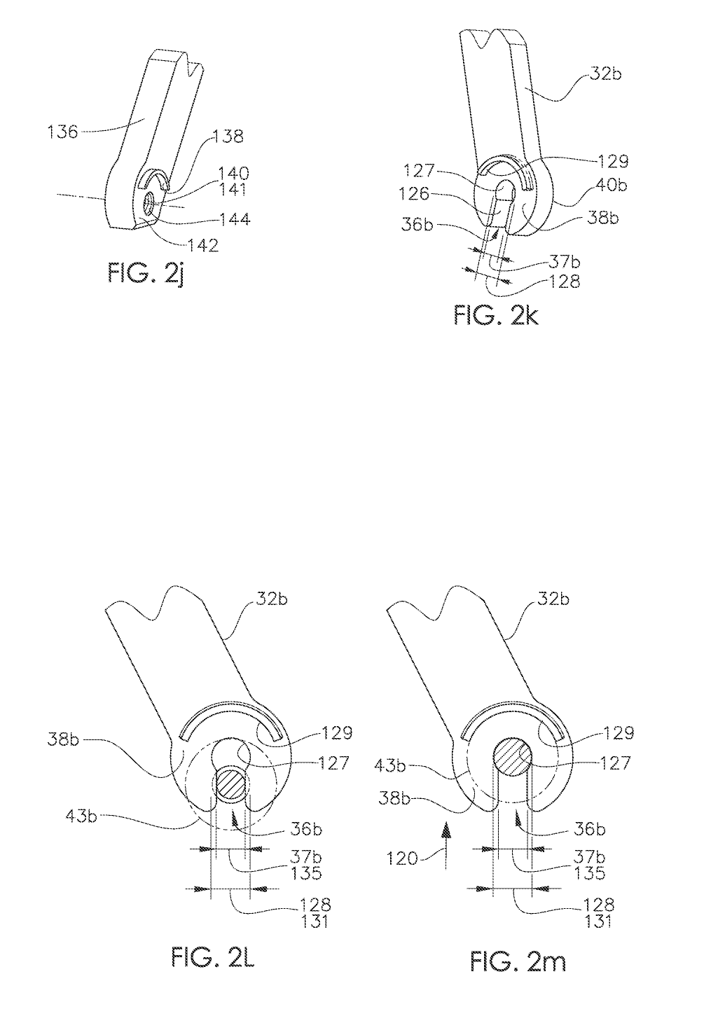

FIGS. 2a-m describe an embodiment of the present invention with a threaded engagement between a control shaft of a hub assembly 30 and the dropout of the frame. This threaded engagement includes a multiple-lead thread engagement. In this embodiment, the frame includes an open-slotted dropout axially opposed to this threaded engagement, for quick and easy wheel removal. FIG. 2a is an exploded view, showing the individual components of this embodiment.

Referring to FIGS. 2a and 2b, dropouts 32a (left dropout) and 32b (right dropout) may be considered mounting portions of the bicycle (not shown) and constitute the portion of the frame (not shown) to which the hub assembly 30 is mounted or connected. Left dropout 32a is of a generally conventional design and includes open slot 36a of slot width 37a between sidewalls 111, axially inboard face 38a, and axially outboard face 40a. Right dropout 32b, as also shown in FIG. 2k, includes an open keyhole slot 36b that is radially stepped to include a narrower necked entrance region 126 of radial width 37b and a wider enlarged circular pilot region 127 of radial width 128. This radial step occurs within the axial region between inboard face 38b and outboard face 40b. Dropout 32b also includes an axially inboard face 38b, and an axially outboard face 40b. Inboard face 38b also includes an axially inwardly projecting alignment face 129 to provide radial positioning location of the alignment surface 43b of axlecap 44. Open keyhole slot 36b has a radially extending open entrance to receive the control shaft assembly 60.

Inboard faces 38a and 38b are axially opposed and face each other, while outer faces 40a and 40b are axially opposed and face away from each other. Width 37a between sidewalls 111 of open slot 36a is sized to receive flats 105 of adapter 100. Width 37b of the necked entrance region 126 of open slot 36b is sized to receive the shank portion 88 of the control shaft 61 and width 128 (shown in FIG. 2k) of the pilot region 127 is sized to receive stepped portion 65. The dropouts 32a and 32b shown here are more typical of the front dropouts of a bicycle frame, but the rear dropouts may be similar in design and it is understood that this design is representative of a wide range of dropout designs, either conventional or unconventional.

The hub assembly 30 includes an axle assembly 24 (and also including axlecap 42), bearing assemblies 33a and 33b, and hub shell 20. In this case, the axle assembly 24 is generally stationary and fixed to the frame of the bicycle, while the hub shell 20 is rotatable about axial axis 28 and about the axle assembly 24 by means of bearing assemblies 33a and 33b. Bearing assemblies 33a and 33b are shown here as conventional “cartridge” type bearing assemblies, including rolling elements, an inner race and an outer race. The hub shell 20 includes two hub flanges 22a and 22b that are adapted to connect with the first ends of spokes (not shown) in the conventional manner. Hub shell 20 includes a second end portion 25 axially disposed to be proximal to handle 66 of the control shaft assembly 60 and to outer face 46b, and a first end portion 26 axially disposed to be distal the handle 66 relative to the second end portion 25 and to be axially proximal outer face 46a. The axle assembly 24 includes axlecap 42, axlecap 44, sleeve 58, and control shaft assembly 60. The control shaft assembly 60 includes the control shaft 61 with spring 97, snaprings 64b and 64c, handle 66, and pivot pin 67. The handle 66 includes radially projecting lever portions 45a and 45b to afford additional tightening torque and leverage when the handle 66 is manipulated by the operator. The handle 66 also includes a pivot tab 69 with a hole 101 therethrough. The sleeve 58 includes an axial opening 78 therethrough with a shoulder 41, and with internal threads 79. Sleeve 58 also includes end face 77, shoulder 80, collar 82, and hole 83 that is sized to accept and preferably to pilot the control shaft 61.

Concentric and coaxial within the sleeve 58 is the control shaft 61, which is both (axially) slideable and rotatable within the sleeve 58 about the axial axis 28. Control shaft 61 includes a shank portion 88 and an enlarged head portion 89, with a grip face 73 serving as a transition surface between shank portion 88 and head portion 89. The shank portion 88 extends axially inwardly from the grip face 73 and includes a cylindrical stepped portion 65 of larger diameter 131 and a shank portion 88 that is concentric with stepped portion 65 and is of smaller diameter 135 such that there is a step or transition surface 75 therebetween. The shank portion 88 may be considered as a radially relieved surface relative to the stepped portion 65 and the stepped portion 65 may be considered as a radially enlarged surface relative to the shank portion 88. The shank portion 88 includes end face 199, and external threads 62 at its engagement end adjacent end portion 99. End face 199 and transition surface 75, which correspond to first and second leading engagement edges of the control shaft 61 respectively, are axially separated by engagement distance 198. The head portion 89, including grip face 73, extends axially outwardly from the grip face 73 and includes a slot 90 to accept the pivot tab 69 of the handle 66, and a cross hole 71 sized to accept the pivot pin 67. Control shaft 61 extends through axlecaps 42 and 44 and sleeve 58 and includes end portion 99 with external threads 62 at its engagement end. Control shaft 61 further includes snaprings 64b and 64c, each nested and engaged in corresponding circumferential snapring grooves, at specific axial locations along its length. Snapring 64b provides an axial end stop for compression spring 97, which is positioned between snapring 64b and end face 70, and which serves to axially bias the control shaft assembly 60 in direction 121 relative to the sleeve 58. Snapring 64c serves to provide an axial travel limit stop for the control shaft assembly 60 relative to the axlecap 44 and to retain the control shaft assembly 60 to the rest of the hub assembly 30.

Axlecap 44 includes outer face 46b, shoulder 55, counterbore 48, collar portion 56, cylindrical alignment surface 43b, end face 70, and an axially extending hole 54 therethrough. Axlecap 44 also includes flats 81 for rotational manipulation with a wrench (not shown). Collar portion 56 includes a threaded portion with external threads 57 to mate with internal threads 68 of the sleeve 58 and a smooth cylindrical portion 63 to pilot the inside diameter of bearing 33b. The diameter 49 of counterbore 48 is sized to receive stepped portion 65.

Axlecap 42 includes end face 46a, face 47, cylindrical alignment surface 43a, and an axially extending hole 50 sized to accept collar 82. Outer faces 46a and 46b are generally axially opposed and face away from each other and preferably have a fixed axial distance 39. Holes 50 and 54 constitute the exposed openings of a continuous axial hole that extends through the sleeve 58 to accept the control shaft 61.

Adapter 100 is also detailed in FIG. 2n and includes externally threaded collar 102, flats 105, hole 104, shoulder 108, end face 103, and a concave alignment surface 106. Collar includes external threads 143 for threadable assembly with nut 110. Hole 104 includes a counterbore 109 portion that extends axially from end face 103 through a portion of hole 104 and that is of a diameter sized to accept the major diameter of external threads 62 of the control shaft 61. Hole 104 also includes an internally threaded portion with internal threads 107 extending axially from the base of the counterbore 109 axially outwardly through the remainder of the collar 102. Internal threads 107 are sized to threadably mate with external threads 62 of the control shaft 61. Flats 105 create a noncircular profile and are sized to engage and key with the sidewalls 111 of slot 36a and serve to prevent the adapter 100 from rotating about the axial axis 28. Flats 105 also serve to prevent the adapter 100 from rotating relative to the nut 110 during assembly with dropout 32a and also to maintain the desired orientation (about the axial axis 28) of the adapter 100. The engagement between flats 105 and slot 36a also serve to maintain the proper alignment of the adapter 100 about the axial axis 28. Nut 110 includes internally threaded hole 112, end face 114, and flats 116.

The adapter 100 is first pre-assembled to dropout 32b such that collar 102 and flats 105 are nested within slot 36a to extend therethrough, with shoulder 108 axially abutting inboard face 38a. Flats 105 are aligned and keyed with sidewalls 111 of the slot 36a. Nut 110 is then threaded onto adapter 100 with internal threads 143 of hole 112 threadably mated to external threads of collar 102, such that end face 114 is axially abutting outboard face 40a. The nut 110 is then further threadably tightened against the adapter 100, by means of a wrench (not shown) engaged to flats 116 to sandwich, clamp, and grip the dropout 32a, with end face 114 bearing and gripping against outboard face 40a and shoulder 108 bearing and gripping against inboard face 38a. The keyed engagement between flats 105 and sidewalls 111 prevents the adapter 100 from rotating while the nut 110 is tightened and also maintains the desired alignment of the adapter 100 relative to the dropout 32a, insuring that other features, such as the alignment surface 106, is in proper alignment to receive the hub assembly 30. This rotatably fixed engagement also insures that the adapter 100 will not spin about the axial axis 28 when the external threads 62 are threadably mated with internal threads 107. End face 103 is axially spaced from inboard face 38b by frame spacing distance 35 that corresponds to the axial hub spacing distance 39 between outer faces 46a and 46b.

As shown in FIG. 2b, which details the hub assembly 30 and corresponds to the retracted position of the control shaft assembly 60, shoulder 80 axially abuts the inner race of bearing assembly 33a and end face 77 axially abuts the inner race of bearing assembly 33b. Outer races of bearing assemblies 33a and 33b are radially and axially fixed in the hub shell 20 in the conventional manner as shown. Thus, sleeve 58 is axially fixed relative to the hub shell 20, with the hub shell 20 rotatable about the sleeve 58 via bearings 33a and 33b about the axial axis 28. Axlecap 44 is threadably assembled to the sleeve 58 as shown, with external threads 57 mated to internal threads 79 and with shoulder 55 axially abutting the inner race of bearing assembly 33b. End face 77 and shoulder 55 serve to axially sandwich and locate the inner race of bearing assembly 33b. Collar portion 56 extends through the inner race of bearing assembly 33b. Similarly, collar 82 extends through the inner race of bearing 33a and within hole 50 to also pilot the axle cap 42. Shoulder 80 and face 47 serve to axially sandwich and locate the inner bearing race of bearing assembly 33a. The opening 78 of sleeve 58 is stepped from a larger diameter adjacent the end face 77 for clearance with spring 97 to the smaller diameter of hole 83 adjacent the collar 82 for radial piloting of the control shaft 61. Sleeve 58 also includes notches 86 at the engagement end for rotational manipulation with a mating wrench (not shown) about the axial axis 28. The assembled axle assembly 24 preferably provides a fixed axial distance between outer faces 46a and 46b as is conventional.

Snapring 64c provides an axial displacement limit stop relative to the axle assembly 24. In the case where the control shaft assembly 60 is withdrawn too far in direction 118, the snapring 64c will abut end face 70 and limit its travel. As such, snapring 64c also serves to insure that the control shaft 61 is positively retained with the axle assembly 24, serving as a convenience to prevent the control shaft assembly 60 from becoming separated from the hub assembly 30. The control shaft 61 also includes head portion 89 with grip face 73, slot 90, and cross hole 71. The pivot tab 69 of the handle 66 is assembled to the head portion 89 by first inserting pivot tab 69 into slot 90 and then inserting pivot pin 67 through cross hole 71 such that the handle 66 is engaged to the head portion 89 in a clevis hinge arrangement. The handle 66 may now be pivoted about the pivot axis 72 relative to the control shaft 61.

For explanation purposes and referring to FIGS. 2a-b, it is understood that an orientation described as “clamp end” or “handle end” refers to an axial location proximal to the handle 66 and distal the end portion 99. Conversely, an orientation described as “toward the engagement end” or “engagement end” refers to an axial location proximal to the end portion 99 and distal the handle 66. The handle end may also be termed the “control end”.

FIG. 2b shows the assembled hub assembly 30, with the handle 66 assembled to the control shaft 61 by means of pin 67. The handle 66 is shown to be pivoted to its open or unfolded position to facilitate its manual manipulation. Control shaft 61 is extending through hole 54 and with spring 97 constrained between end face 70 and snapring 64b. Axlecap 44 is threadably assembled to the sleeve 58 as described above. This threadable assembly may be tightened with the aid of wrenches (not shown) engaged with flats 81 and with notches 86 to axially sandwich the inner race of bearing assembly 33b. A portion of collar 82 protrudes through bearing 33a to axially overlap and radially pilot the hole 50 of axlecap 42, with o-ring 87 providing a frictionally gripped retaining means therebetween in the conventional manner.

The compression spring 97 surrounds the control shaft 61, with its ends constrained and abutting the snapring 64b of the control shaft 61 and the end face 70 of the axlecap 44. With the control shaft assembly 60 in the retracted position, as shown in FIGS. 2b-c, the compression spring 97 is axially compressed and pre-loaded to provide a bias force to axially shuttle the control shaft assembly 60 in direction 121 towards its extended position as shown in FIGS. 2e and 2i. The term “axial shuttle” refers to an axial displacement that may or may not include rotation about the axial axis 28.

The control shaft 61 is shown in FIGS. 2b-c to be in the axially retracted position relative to the sleeve 58 and axle assembly 24. The control shaft assembly 60 has been axially withdrawn toward the handle end in direction 118 (the “retracted direction”) until snapring 64c contacts the end face 70. This retracted position causes the spring 97 to be compressed to axially bias the control shaft assembly 60 in direction 121. In this retracted position, the axial gap 98 between outer face 46b and grip face 73 is considered “open” and there is axial clearance 147 (shown in FIG. 2g) between outboard face 40b and transition surface 75 adjacent the handle end. Additionally, in this retracted position, the end face 199 of the control shaft 61 may be flush or slightly axially inwardly recessed by recess distance 148 relative to the outer face 46a as shown. It is preferred that axial clearance 147 is equal or close to the recess distance 148 so that the end portion 99 is axially disengaged from the counterbore 109 by the same or similar amount as the transition surface 75 is disengaged from the pilot region 127.

FIG. 2c shows adapter 100 and nut 110 as firmly assembled to grip the left dropout 32a as described hereinabove. Once firmly secured to the dropout 32a, the adapter 100 may be considered as an extension of the dropout 32a. The hub assembly 30 is shown positioned prior to its assembly with the dropout 32b and adapter 100. The handle 66 is in its unfolded and open position. The operator has pulled the handle 66 in direction 118 to insure that the control shaft assembly 60 is in the retracted position, with gap 98 open and expanded and with the engagement end of the control shaft assembly 60 recessed from outer face 46a. The transition surface 75 is preferably axially aligned to be axially coincident or axially outboard of the outer face 40b such that the shank portion 88 is axially aligned with open slot 36b. Outer face 46a is also generally axially aligned with end face 103 and outer face 46b is generally axially aligned with inboard face 38b. The handle 66 serves to provide geometry for the operator to easily manipulate and control the control shaft assembly 60 as described herein. As a convenience and to prevent the operator from retracting the control shaft assembly 60 too far in direction 118, snapring 64c is provided to bear against the end face 70 of the axlecap 44 as a positive axial travel limit stop. It is noted that, as shown in FIGS. 2a-m, the control shaft assembly 60 is axially retained and engaged to the hub assembly 30 such that the control shaft assembly 60 may not be inadvertently removed from the hub assembly 30.

Next, as shown in FIGS. 2d and 2g, the hub assembly 30 is moved in the generally radial direction 120 relative to the dropouts 32a and 32b such that alignment surface 43a is radially abutting and nested with alignment surface 106 and alignment surface 43b is radially abutting and nested with alignment surface 129 to provide radial alignment between the hub assembly 30 and dropouts 32a and 32b. These nested engagements serve to provide a radial depth stop of the hub assembly 30 relative to the dropouts 32a and 32b in the conventional manner. Outer face 46a is also adjoining end face 103 while outer face 46b is also adjoining inboard face 38b to provide axial alignment between the hub assembly 30 and dropouts 32a and 32b. The external threads 62 are now radially aligned with counterbore 109 and the stepped portion 65 is now radially aligned with pilot region 127.

The radially position engagement between alignment surfaces 43a and 43b and respective alignment surfaces 106 and 129 is provided as a convenience to center and radially pre-align the control shaft 61 with hole 104 and pilot portion 127 respectively. This pre-alignment may serve to permit the smooth and unrestricted axial shuttling and circumferential rotation of the control shaft 61 during the assembly and disassembly of the hub assembly 30 with the dropouts 32a and 32b as described herein. Alternatively, other geometries and/or arrangements may be utilized to provide this radial pre-alignment, In the absence of such a pre-alignment engagement, the control shaft may bear directly against the dropouts 32a and 32b, which may result in binding and friction therebetween, which could impede the smooth and unrestricted axial shuttling and circumferential rotation of the control shaft 61.

The handle 66 serves to provide geometry for the operator to easily manipulate and control the control shaft assembly 60 as described herein. The operator may hook their fingers under lever portions 45a and 45b to withdraw the control shaft assembly 60 in direction 118, as shown in FIGS. 2b-d and 2g, to compress the spring 97 and place the control shaft assembly in the retracted position.

As a convenience and to prevent the operator from retracting the control shaft assembly 60 too far in direction 118, snapring 64c is provided to bear against the end face 70 of the axlecap 44 as a positive axial travel limit stop. It is noted that, as shown in FIGS. 2a-m, the control shaft assembly 60 is axially retained and engaged to the hub assembly 30 such that the control shaft assembly 60 may not be inadvertently removed from the hub assembly 30.

Next, as shown in FIG. 2h, the operator has unhooked their fingers and manually released the handle 66, allowing the spring 97 to linearly displace and shuttle the control shaft assembly 60 in direction 121 (the “extending direction”) to advance the control shaft assembly 60 into the “pre-engaged position” such that the end face 199 is now protruding axially outwardly from outer face 46a to axially overlap counterbore 109 by overlap distance 117. Counterbore 109 circumscribes end portion 99, which is thus radially retained and engaged with the left dropout 32a. Simultaneously, in this pre-engaged position, the transition surface 75 and a portion of the stepped portion 65 is now axially overlapping the counterbore 109 by overlap distance 125. Collar portion 65 is now radially retained and engaged with the dropout 32b. It may be considered that counterbore 109 and pilot region 127 both include retaining surfaces that serve to radially retain the hub assembly 30. It may also be considered that end portion 99 and collar portion 65 may both be considered as having engagement surfaces that serve to radially engage with their respective mating engagement surfaces. End portion 99 and stepped portion 65 may be considered as engagement surfaces of the control shaft 61 that are axially spaced corresponding to distance 198. As the control shaft 61 is axially shuttled, both of these engagement surfaces are simultaneously shuttled.

As the control shaft assembly 60 is axially shuttled as described, it may be preferable that this axial overlap 117 of end face 199 be generally equal to the axial overlap 125 of the transition surface 75 so that both of these radial engagements are initiated generally simultaneously during this assembly sequence described herein. This also insures that these two radial engagements will release generally simultaneously during disassembly of the hub assembly 30 from the dropouts 32a and 32b. Similarly, it may be preferable that hub spacing distance 39 is equal to or nearly equal to engagement distance 198 such that, as control shaft 60 is axially shuttled in direction 121, the radial overlie engagements between end portion 99 and counterbore 109 and between collar portion 65 and pilot region 127 are initiated simultaneously or nearly simultaneously.

Due to tolerances and design restrictions, it may not be possible to insure that distances 117 and 125 are absolutely equal. However, if distances 117 and 125 are within 3 millimeters or, more preferably, within 1 millimeter of each other, the control shaft assembly 60 will still be considered to have simultaneous radial engagement initiation and simultaneous radial release initiation from dropouts 32a and 32b. By coordinating and axially “timing” these two axial overlap distances 117 and 125, the radial engagement of both the handle end and the engagement end will initiate simultaneously as the control shaft assembly 60 is axially shuttled in direction 121. This reduces the possibility that the hub assembly 30 will not hang up or become misaligned as it is installed and/or removed from the dropouts 32a and 32b.

This simultaneous initiation of both of these overlie engagements causes both the control end and handle end of the control shaft assembly 60 to be optimally radially piloted and pre-engaged so that, once the pre-engagement position is initiated (by simply manually releasing the spring-loaded control shaft assembly 60), the control shaft 61 maintains its coaxial alignment such that the external threads 62 are properly aligned with internal threads 107 and the stepped portion 65 is properly aligned with the pilot region 127. Further, these two overlie engagements, which are also maintained and supported by the axial preload provided by the spring 97, provide a significant safety feature and insure that the hub assembly 30 will not become inadvertently separated or dislodged from the dropouts 32a and 32b, even if the threadable engagement between internal threads 109 and external threads 62 is not initiated. Also, outer faces 46a and 46b are now closely located between end face 103 and inboard face 38b for axial engagement between the hub assembly 30 and the dropouts 32a and 32b. The hub assembly 30 is thus also loosely retained to the dropouts 32a and 32b.

If the axial overlap 117 is significantly greater than the axial overlap 125, then the radial overlie engagement between the end portion 99 and the counterbore 109 will be axially initiated prior to the radial overlie engagement between the stepped portion 65 and the pilot region 127. Thus, during this instant, the handle end of the control shaft assembly 60 is not radially retained and may be radially displaced and offset while the end portion 99 remains radially piloted and aligned within the counterbore 109. This may allow the control shaft assembly 60 to become cocked and misaligned such that the threaded engagement between external threads 62 and internal threads 107 may also be misaligned, causing cross-threading and/or damage to the control shaft 61 and/or the adapter 100. Further, with only one overlie engagement, the safety benefit of the pre-engagement is significantly compromised and possibly defeated. Similarly, if the axial overlap 125 is significantly greater than the axial overlap 117, then the radial overlie engagement between the stepped portion 65 and the pilot region 127 will be axially initiated prior to the radial overlie engagement between the end portion 99 and the counterbore 109. Thus, during this instant, the end portion 99 of the control shaft assembly 60 is not radially retained and may be radially displaced and offset while the stepped portion 65 remains radially piloted and aligned within the pilot region 127. This may allow the control shaft assembly 60 to become cocked and misaligned such that the stepped portion 65 may bind against the pilot region 127, adversely affecting the easy assembly of the hub assembly 30 with the dropouts 32a and 32b and possibly damaging the control shaft 61 and/or dropout 32b.

Next, as shown in FIG. 2e, the operator may then manually rotate the handle 66 in direction 122, by using thumb and forefinger as a torque couple lever portions 45a and 45b to twist and rotate the control shaft 61 in direction 122 in a manner similar to that of a wingnut. This serves to threadbly engage external threads 62 with internal threads 107 and also to advance the control shaft assembly 60 further in direction 121, serving to reduce gap 98 until grip face 73 axially abuts outboard face 40b. Outer face 46a is abutting end face 103 and outer face 46b is abutting inboard face 38b and the control shaft assembly 60 is in the engaged position. With the handle 66 in the open position as shown, the lever portions 45a and 45b may function as the “wings” of a wingnut to provide coupled manual leverage amplification for rotation of the control shaft assembly 60 about the axial axis 28. Further threadable tightening of the handle 66 in direction 122 serves to axially draw end face 103 toward grip face 73, thereby firmly clamping dropout 32b between grip face 73 and outer face 46b and firmly clamping outer face 46a against end face 103. The end portion 99 is now fully axially overlapping the adapter 100 and the stepped portion 65 is now fully axially overlapping the dropout 32b to more positively radially retain the hub assembly 30 to the dropouts 32a and 32b. With the handle 66 fully tightened as described above, the hub assembly 30 is now in the clamped position relative to dropouts 32a and 32b and the hub assembly 30 is firmly clamped and installed with the dropouts 32a and 32b.

The stepped portion 65 is now axially overlapping the dropout 32b by distance 125′ to more completely axially overlap pilot region 127 to be further radially retained and engaged with the dropout 32b. Similarly, the end portion 99 is axially overlapping the adapter 100 by distance 117′ to be further radially retained and engaged with the dropout 32a. The radial retaining afforded by axial overlap distances 117′ and 125′ provide an added measure of safety in insuring that the hub assembly 30 remains engaged to the dropouts 32a and 32b even if the control shaft assembly 60 was threadably loosened slightly such that the axially gripping of the dropout 32b were inadvertently reduced.

Next, as shown in FIGS. 2f and 2i, the handle 66 may next be folded and pivoted about pin 67 and pivot axis 72 in direction 123 to its “closed” position to reduce the overall axial width 124 of the hub assembly 30 and to create a more aerodynamic and compact aesthetic appearance, while also and reducing the propensity for inadvertent snagging on external objects. This folded or collapsed orientation of the handle 66 serves to provide the aesthetics and convenience of a lower profile assembly, as preferred by many cyclists.

The procedure for uninstallation and removal of the hub assembly 30 from the dropouts 32a and 32b is basically the reverse of the assembly and installation sequence just described. For removal, the handle 66 is first unfolded to the position shown in FIG. 2e. Next, the control shaft assembly 60 is unscrewed, in a direction opposite to direction 122, via lever portions 45a and 45b of the handle 66 until the external threads 62 are disengaged from the internal threads 107, displacing the control shaft assembly 60 in direction 118 into the pre-assembled position shown in FIG. 2h. The operator may then hook their fingers under lever portions 45a and 45b or else manually pinch the handle 66 or otherwise manually grasp the handle 66 to retract and withdraw the control shaft assembly 60 in direction 118 against the preload of spring 97 until the snapring 64c is abutting end face 70. End face 199 is now axially coincident or inboard of end face 103 and transition surface 75 is axially coincident or inboard of outboard face 40b as shown in FIGS. 2b. At this position of the control shaft assembly 60, the end portion 99 is no longer axially overlapping the counterbore 109 and the stepped portion 65 is no longer axially overlapping the pilot portion 127 and the aforementioned radial engagements are released, permitting the hub assembly 30 to be radially removed from the frame opposite to direction 120 to complete the removal or uninstallation procedure. Since distances 117 and 125 are equal or nearly equal, the release of these two radial engagements are axially timed to initiate and occur generally simultaneously as mentioned hereinabove.

Note that, as the control shaft assembly 60 is retracted in direction 118 past the pre-assembled position, the end portion 99 is radially released from counterbore 109 simultaneous to the collar portion 65 being radially released from the pilot region 127. By coordinating these two axial overlap distances, the radial release of both the end portion 99 and the collar portion 65 will occur simultaneously as the control shaft assembly 60 is axially retracted in direction 118. This reduces the possibility that the hub assembly 30 will hang up adjacent either outer face 46a or 46b, allowing the hub assembly to be skewed or otherwise misaligned as it is removed or uninstalled from the dropouts 32a and 32b.

While the hub assembly 30 is retained to dropouts 32a and 32b with the control shaft assembly 60 in the pre-engaged position, this retained configuration normally serves as a convenience to maintain the axial alignment of the control shaft assembly 60 with respect to the dropouts 32a and 32b. The pre-engaged position also serves as a safety retaining means to restrict separation of the hub assembly 30 from the dropouts 32a and 32b in the event that the control shaft assembly 60 is inadvertently not placed in the clamped position. While the clamped position is not required to assemble the hub assembly 30 to the dropouts 32a and 32b, the threadable assembly associated with the clamped position is preferred and serves to fortify and solidify this assembly.

While the embodiment of FIGS. 2a-m shows the control shaft assembly 60 as biased by the compression spring 97 toward the extended position, it is envisioned that the control shaft assembly 60 may alternatively be biased toward the retracted position. For example, the compression spring 97 may instead be positioned between snapring 64b and shoulder 41 to bias the control shaft assembly 60 in direction 118. It should be noted that the spring-bias provided by spring 97 as described herein provides a convenience and is not a requisite for the proper functionality of the present invention.

In addition to being axially shuttled as described, the control shaft 61 has a generally smooth circular cylindrical surface such that, in both the extended and retracted positions, the control shaft assembly 60 may be rotated relative to the sleeve 58 about the axial axis 28. Such rotation is especially beneficial when attempting to threadably engage external threads 62 with internal threads 107. Meanwhile, adapter 100 is axially and rotationally fixed to the dropout 32a of the frame (not shown). Thus, the axially displaceable (in directions 118 and 121) control shaft assembly 60 of the hub assembly 30 is operative to selectively engage the dropout 32a. It is noted that the control shaft assembly 60 is freely rotatable at all points in its axial travel. This is a preferred feature, since the control shaft 61 must be rotatable to threadably assemble the external threads 62 with internal threads 107. In an alternative design, the control shaft assembly 60 may be rotatably keyed to the sleeve 58 or another portion of the axle assembly 24 about axial axis 28 or else the control shaft assembly 60 may employ a rotationally yieldable detent mechanism relative to the sleeve 58.

The combined assembly of the sleeve 58 and axlecaps 42 and 44 serve as an outer axle assembly that is discreet from the control shaft assembly 60. This outer axle assembly is axially fixed relative to the hub shell 20, while the control shaft assembly may be axially shuttled within this outer axle assembly. Alternatively, the components of the outer axle assembly may be omitted and the control shaft assembly may be axially shuttled within the bearings 33a and 33b.

FIG. 2j describes an alternate dropout 136 that may be substituted for the dropout 32a, the adapter 100, and the nut 110. Dropout 136 is a monolithic or an integral assembly that incorporates the geometry and features of the adapter 100. Dropout 136 includes hole 140, inboard face 142, and a concave alignment surface 138. Hole 140 includes a counterbore 144 portion that extends axially from inboard face 142 through a portion of hole 140 and is of a diameter sized to accept the major diameter of external threads 62 of the control shaft 61. Hole 140 also includes an internal thread 141 portion extending axially from the base of the counterbore 144 through the remainder of the dropout 136. Internal threads 141 are sized to threadably mate with external threads 62 of the control shaft 61.

As shown in FIG. 2a, dropout 32a is of a generally conventional “slotted” design and includes an open slot 36a to receive a conventional hub assembly (not shown). Adapter 100 and nut 110 are required to adapt dropout 32a to receive the hub assembly 30, as shown in FIG. 2c. Alternatively, dropout 136 may be substituted for the combined assembly of dropout 32a, adapter 100, and nut 110. As shown in FIG. 2j, dropout 136 is purpose-built to receive the hub assembly 30 and incorporates geometry and features otherwise included in the adapter 100. These geometries and features have similar functionality to the analogous geometries and features associated with the adapter 100 and as described herein. Dropout includes inboard face 142, which corresponds to inboard face 38a, and alignment surface 138, which corresponds to alignment surface 106, and hole 140 with internal threads 141 and counterbore 144, which corresponds to hole 104 with internal threads 107 and counterbore 109. Dropout 136 may thus be substituted for dropout 32 and adapter 100 and nut 110 to receive the hub assembly 30 as described in FIGS. 2c-e.

FIGS. 2L and 2m illustrate the interaction between the control shaft 61 and the dropout 32b in greater detail. For clarity and simplification of illustration, these two figures show only the dropout 32b and the control shaft 61, while the most of the other components of the hub assembly 30 are not shown here. FIG. 2L corresponds to the transition between the assembly sequence shown in FIG. 2c and FIG. 2d, with the shank portion 88 passing through the necked entrance region 126 of open slot 36b in direction 120. The shank portion 88 has a cross-sectional diameter 135 that is smaller and radially relieved relative to diameter 131. It may be seen that the slot width 37b is sized to let the shank portion 88 pass therethrough, however the slot width 37b is smaller than the diameter 131 of the stepped portion 65. As shown in FIG. 2m, the hub assembly 30 is further advanced in direction 120 until the alignment surface 43b is radially abutting and nested within alignment face 129 (as shown in FIG. 2g). The control shaft assembly 60 has been axially advanced in direction 121 until the stepped portion 65 is axially overlapping the pilot region 127, which corresponds to the assembly sequences of FIGS. 2e, 2f, 2h, and 2i. As illustrated in FIG. 2m, the stepped portion 65 has been axially shuttled to be positioned within the pilot region 127 of the open slot 36b. The diameter 131 of stepped portion 65 is sized to be larger than the width 37b of the necked entrance region 126 such that the control shaft 61 is now axially piloted and radially retained within the pilot region 127, thereby causing the hub assembly 30 to be radially retained with the dropout 32b and preventing the hub assembly 30 from becoming separated from the dropout 32b. FIG. 2m describes the interaction between the stepped portion 65 and the pilot region 127 in both the pre-engaged and engaged positions.

Finally, as shown in FIGS. 2f and 2i, the handle 66 may next be folded and pivoted about pin 67 and pivot axis 72 in direction 123 to its “closed” position to reduce the overall axial width 124 of the hub assembly 30 and to create a more aerodynamic and compact aesthetic appearance, while also and reducing the propensity for inadvertent snagging on external objects. While the capability to fold handle 66 as described herein is not a requirement for proper function of this embodiment, it serves to provide the significant convenience of a lower profile assembly, as preferred by most cyclists.

It should be noted that the spring-bias provided by spring 97 as described herein provides a convenience and is not a requisite for the proper functionality of the present invention.

As shown in FIGS. 2b-d and 2g, with the control shaft assembly 60 in the retracted position, the end portion 99 is shown to be slightly axially recessed relative to the outer face 46a. Alternatively, the detent mechanism may be arranged such that the end portion 99 may be axially flush or else axially protruding from outer face 46a in the retracted position.

Since it is highly desirable to allow for fast installation of the hub assembly, it is preferable to use a “fast” multiple-lead thread form for the threadable engagement between external threads 62 and internal threads 107, rather than a common conventional single-lead thread form. The embodiment of FIGS. 2a-m utilizes such a multiple-lead thread in the form of a double-lead thread (also sometimes termed a “twin-start”or “two-start” thread). In the example described in FIGS. 2a-m, it is generally preferable to utilize a double-lead or triple-lead thread form, as further increasing the number of leads may adversely reduce the axial clamping force provided by this threaded engagement.

It is noted that the control shaft assembly 60 is freely rotatable at all points in its axial travel. This is a preferred feature, since the control shaft 61 must be rotatable to threadably assemble the external threads 62 with internal threads 107. However, the control shaft assembly 60 may alternatively be rotationally fixed to the sleeve 58 or else the control shaft assembly 60 may employ a rotational detent mechanism relative to the sleeve 58.

While the alignment surfaces 106 and 129 provide a convenient circular cylindrical surface to nest with the circular cylindrical surface geometry of the alignment surfaces 43a and 43b, these alignment surfaces may alternatively have a wide range of geometries, some of which may not be circular, that may create a rotationally keyed engagement therebetween. As a further alternative, the alignment surfaces 106 and/or 129 may be eliminated entirely and the control shaft 61 may instead serve to provide the radial locating interface with dropouts 32a and/or 32b.

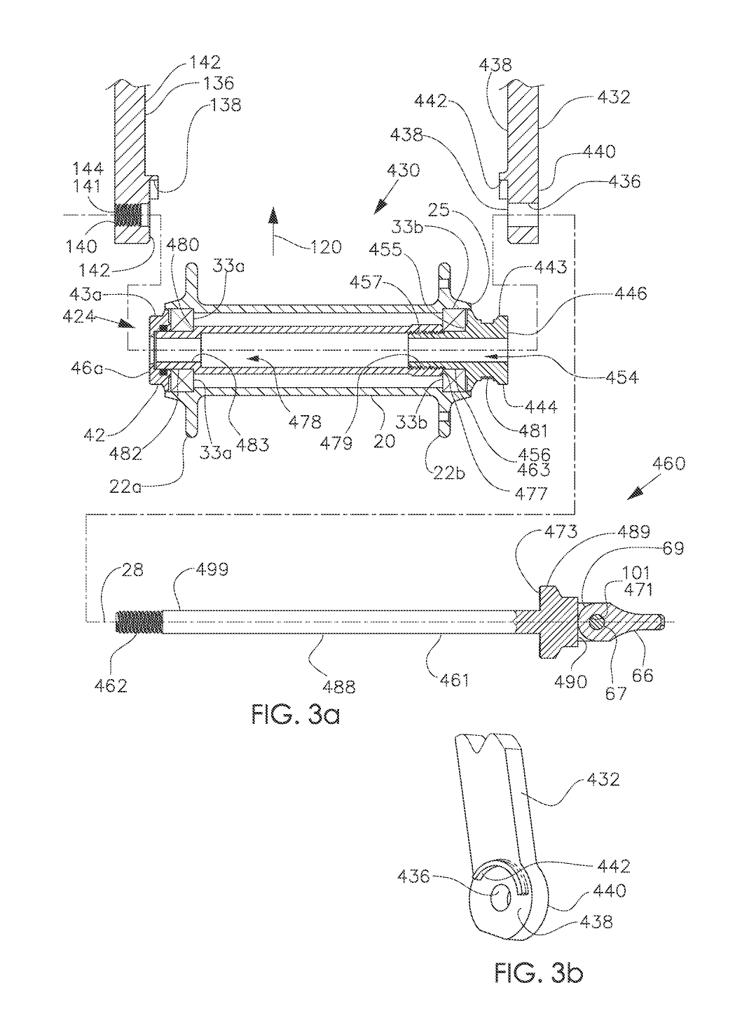

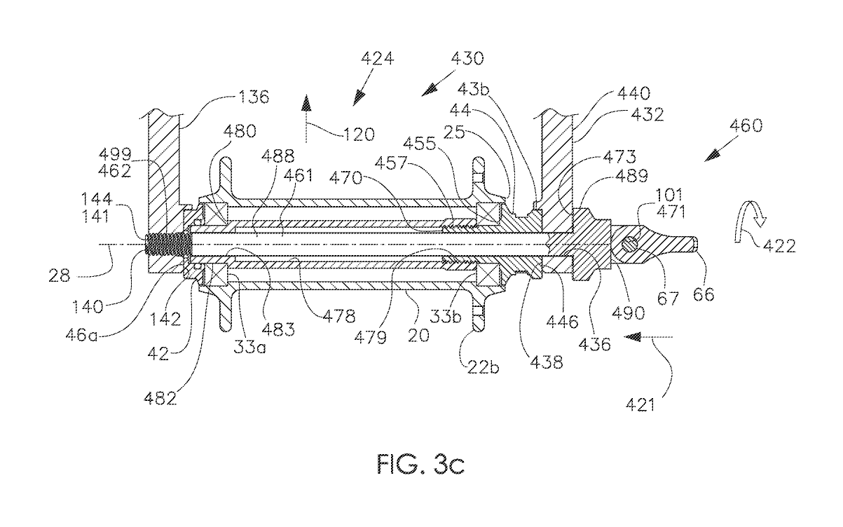

FIGS. 3a-c describe a second embodiment where the articulating lever 66 may be applied to a conventional through-axle arrangement. Orientation conventions are identical to those described in FIGS. 2a-m. The hub assembly 430 is comprised of axle assembly 424, control shaft assembly 460, hub shell 20, and bearings 33a and 33b. The axle assembly 424 includes axle cap 444, sleeve 458, and axle cap 42. The control shaft assembly 460 includes the control shaft 461, handle 66, and pivot pin 67. Handle 66, pivot pin 67, hub shell 20, bearings 33a and 33b, and axle cap 42 are identical to those described in FIGS. 2a-m.

The control shaft 461 includes a shank portion 488 and an enlarged head portion 489. The head portion 489 includes a grip face 473, a slot 490 to accept the pivot tab 69 of the handle 66, and a cross hole 471 sized to accept the pivot pin 67. The shank portion 488 includes end portion 499 with external threads 462 at its engagement end. External threads 462 are multi-lead threads to threadably engage with multi-lead internal threads 141 of dropout 136 upon assembly. The handle 66 is assembled to the control shaft 461 by means of pin 67 and as also described hereinabove.

The sleeve 458 includes an axial opening 478 therethrough, with internal threads 479 and end face 477 at its handle end. Sleeve 458 also includes shoulder 480, collar 482, and hole 483 at its engagement end that is sized to accept and radially pilot the control shaft 461. Axlecap 444 includes outer face 446, alignment surface 443, shoulder 455, collar portion 456, and an axially extending hole 454 therethrough. Axlecap 444 also includes flats 481 for rotational manipulation with a wrench (not shown). Collar portion 456 includes a threaded portion with external threads 457 to mate with internal threads 479 of the sleeve 458 and a smooth cylindrical portion 463 to pilot the inside diameter of bearing 33b. Holes 483 and 454 constitute the exposed openings of a continuous axial hole that extends through the axle assembly 424 to accept the shank portion 488.

Dropouts 432 and 136 may be considered mounting portions of the bicycle (not shown) and constitute the portion of the frame (not shown) to which the hub assembly 430 is mounted or connected. Dropout 136 is identical to that described in FIG. 2j. Dropout 432 is similar to right dropout 32b and is detailed in FIG. 3b to show an axially inboard face 438a, an axially outboard face 440a, and alignment surface 442. Axially extending hole 436 is substituted for open slot 36b. Hole 436 is sized to accept the shank portion 488 of the control shaft 461. In comparison with open slot 36b, hole 436 is an enclosed hole that does not permit the control shaft 461 to be radially removed therefrom. Inboard faces 438 and 142 are axially opposed and face each other. The dropouts 432 and 136 shown here are more typical of the front dropouts of a bicycle frame, but the rear dropouts may be similar in design and it is understood that this design is representative of a wide range of dropout designs, either conventional or unconventional.

FIG. 3c shows the hub assembly 430 as assembled to the dropouts 432 and 136. The hub assembly 430 is first positioned between the dropouts 432 and 136 as shown, with alignment surfaces 43a and 443 radially nested with alignment surfaces 138 and 442 respectively. Next, the shank portion 488 is passed (in direction 421) through hole 436, hole 454, hole 478, hole 483, and finally threadably assembled to hole 140, with external threads 462 threadably engaged to internal threads 141. As the handle 66 is manually manipulated to tighten the threadable engagement, the axial distance between grip face 473 and outer face 446 contracts, which serves to axially sandwich and clamp the dropout 432 with grip face 473 bearing against outboard face 440 and outer face 446 bearing against inboard face 438. Simultaneously, dropouts 432 and 136 are drawn toward each other with inboard faces 438 and 142 bearing against outer faces 446 and 46a respectively to axially clamp and sandwich the axle assembly 424 therebetween.

The arrangement of the hub assembly 430 and dropouts 432 and 136, as well as the assembly therebetween is schematically typical for conventional prior-art through-axle arrangements well known in industry. However, prior-art through-axle arrangements commonly utilize a secondary tool, such as a hex key or a wrench to tighten the control shaft, whereas the present invention utilizes an articulating and pivotally folding handle to facilitate the manual tighten the control shaft assembly 460. Unlike a separate external tool that must be kept on hand and may easily become lost, the handle 66 remains connected to the control shaft 461 and cannot become separated or lost. The conventional quick-release lever has a lever axis that is perpendicular to the pivot axis, which allows the handle to pivot and flop when manipulated (particularly in the axial direction). In contrast, the pivot axis 72 of the present invention is parallel to the lever axis (447a and 447b), which greatly reduces the propensity for the handle to pivot and flop when manipulated.

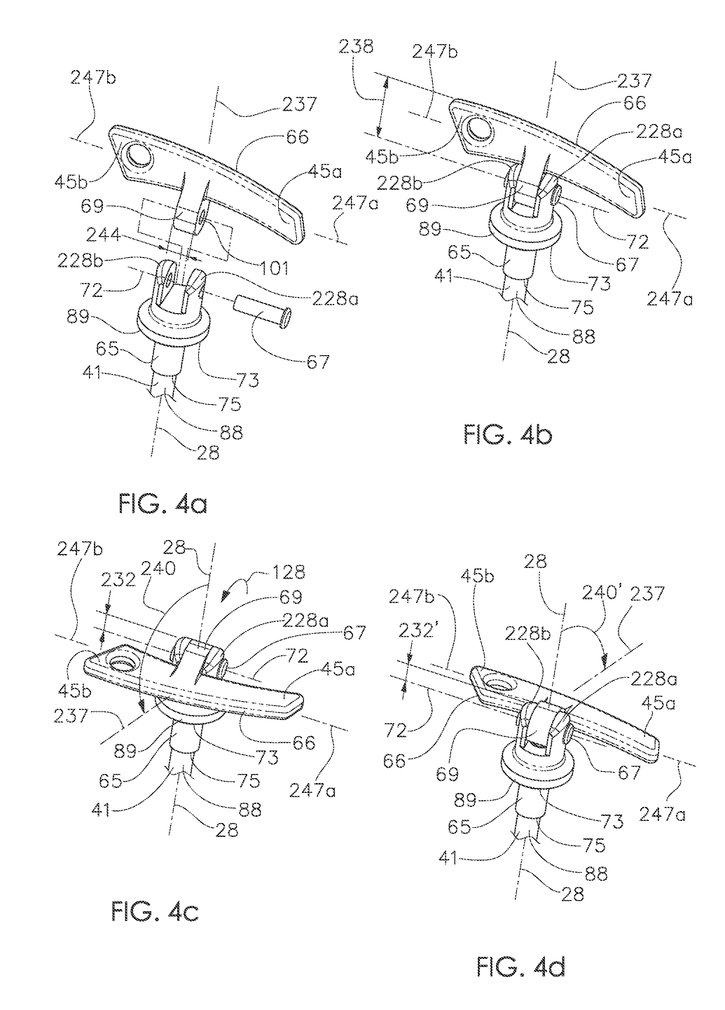

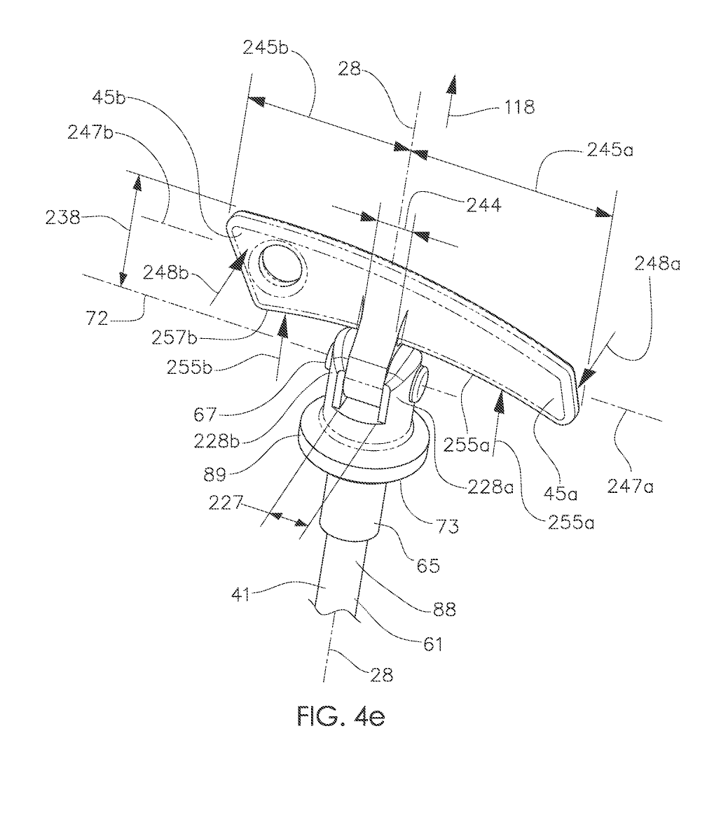

FIGS. 4a-e are representative to describe the handle 66 of FIGS. 2a-m, and its interaction with the control shaft assembly 60, in greater detail. FIG. 4a describes the assembly of the handle 66 with the head portion 89, including pivot pin 67. FIG. 4a is an exploded view that shows how the handle 66 is assembled to the head portion 89 by means of pivot pin 67. The handle 66 includes a handle axis 237 while lever portions 45a and 45b include arm lengths 245a and 245b respectively and lever axis 247a and 247b respectively. Pivot tab 69 serves as a hinge knuckle of knuckle width 244 and slot 90 has a slot width 227 sized to receive the pivot tab 69. Slot 90 serves to bifurcate head portion 89 to create hinge knuckles 228a and 228b. It is noted that handle axis 237 is generally perpendicular to lever axis 247a and 247b, while lever axis 247a and 247b are generally parallel to pivot axis 72.

FIG. 4b shows the handle 66 and pivot pin 67 next assembled to the head portion 89 to create a hinge knuckle between the handle 66 and the head portion 89, where the handle 66 may be pivoted about pivot axis 72. The handle 66 is shown in the open and unfolded position, where lever portions 45a and 45b are optimally aligned to be manually manipulated by the operator's fingers, with the handle axis 237 generally parallel to the axial axis 28. The handle 66 extends axially outboard of the pivot axis 72 by axial distance 238.

FIG. 4c shows the handle 66 as next folded and pivoted in direction 123 about pivot axis 72 by angle 240 (shown to be approximately 90 degrees) to a first folded position. The handle axis 237 is now generally perpendicular to the axial axis 28 and the handle 66 now extends axially outboard of the pivot axis 72 by axial distance 232, which is significantly reduced relative to axial distance 238 thus providing a compact and low-profile arrangement for enhanced aesthetics and aerodynamics. FIG. 4d shows the handle 66 as next folded and pivoted in direction 123′ about pivot axis 72 to a second folded position that is approximately 180 degrees from the first folded position. The handle 66 now extends axially outboard of the grip face 73 by axial distance 232′, which is reduced relative to axial distance 238. It is seen that the handle 66 has two folded positions that are opposed to each other. This gives the operator two different folding options such that the folded handle may be optimally aligned for clearance with other components of the bicycle or for other function.

FIG. 4e is identical to FIG. 4b and shows these components in greater detail. Handle 66 is a generally “T”-shaped handle to include generally radially opposed lever portions 45a and 45b. This allows the operator to apply a coupled twisting force to the lever 66 consisting of circumferentially opposed leverage forces 248a and 248b to apply torque to the control shaft assembly 60 about axial axis 28 in order to tighten the threaded connection between external threads 62 and internal threads 107 and to achieve the engaged position. Conversely, if applied in the reverse direction, leverage forces 248a and 248b are reversed to apply torque to the control shaft assembly 60 in order to loosen this threaded connection toward disassembly of the hub assembly 30 from the dropouts 32a and 32b. Since handle 66 is generally T-shaped with hooked or undercut geometry, this may provide the preferable ergonomic geometry where the operator's fingers (not shown) may hook and cradle the underside hook surfaces 257a and 257b to pull and retract the control shaft assembly 60 in direction 118 with retraction forces 255a and 255b respectively during removal or disassembly of the hub assembly 30 relative to dropouts 32a and 32b. These hook surfaces 257a and 257b serve to facilitate the manual manipulation and enhance the manual gripping and control of the control shaft assembly 60, especially when withdrawing the handle 66 axially outwardly.

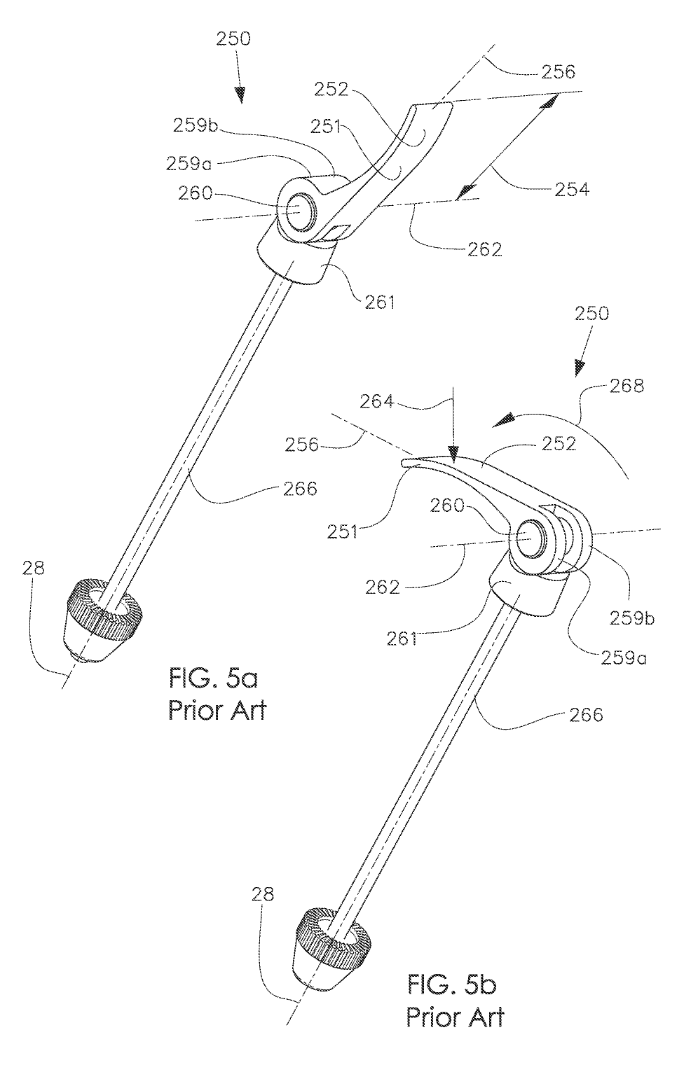

FIGS. 5a-c describe a conventional quick release skewer assembly 250 that is well known in industry. In order to contrast the configuration and operation lever 66 of the present invention relative to the prior art, the lever portion of this quick release skewer assembly 250 will be examined. Handle 251 includes a lever portion 252 with an arm length 254 that extends along lever axis 256, and a lever width 258. Handle 251 pivots about pivot pin 260 and pivot axis 262. The lever axis 256 is perpendicular to the pivot axis 262, which is in contrast to the handle 66 where the lever axis 247a and 247b are generally parallel to the pivot axis 72. The lever width 258 is also relatively narrow in comparison to the sum of arm lengths 245a and 245b. It should also be noted that the handle 66 of the present invention is functional to permit manual manipulation to provide a rotational torque of the control shaft assembly 60 about the axial axis 28. In contrast, the handle 251 of the skewer assembly 250 is functional to drive a cam to provide an axial clamping load to the skewer shaft 266. Thus, the function of lever 66 is very different from the function of lever 252. Handle 250 is designed to be manually manipulated to apply force 264 to the lever portion 252 in a direction perpendicular to the pivot axis 262 that serves to pivot the handle 251 in direction 268 about the pivot axis 262. As handle 251 is pivoted in direction 268, cam surfaces 259a and 259b drive follower washer 261 in direction 263. In contrast, the handle 66 is designed to be manually manipulated to apply forces 248a and 248b to the lever portions 45a and 45b in a plane that is generally parallel to the pivot axis 72.

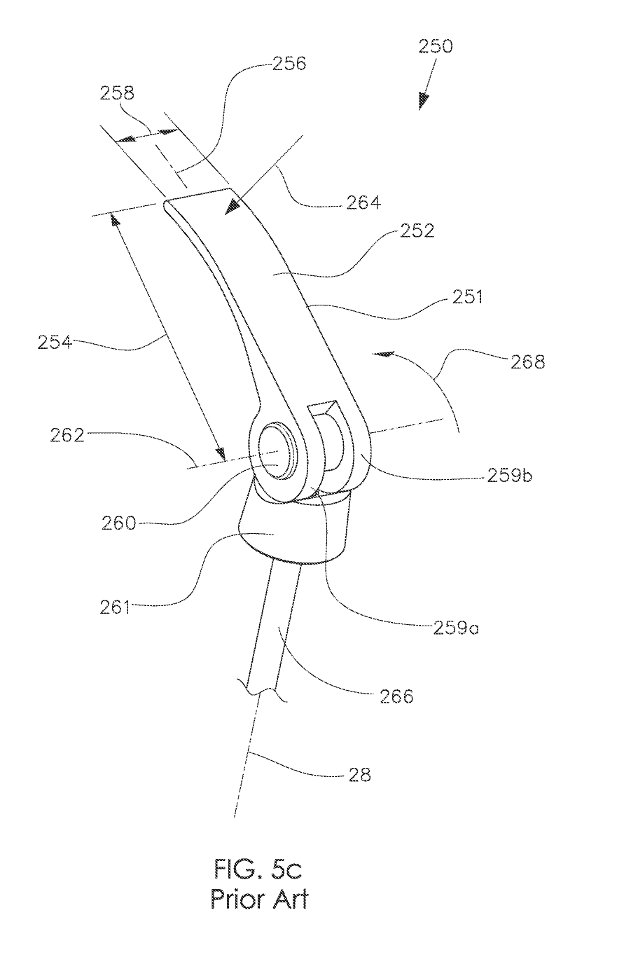

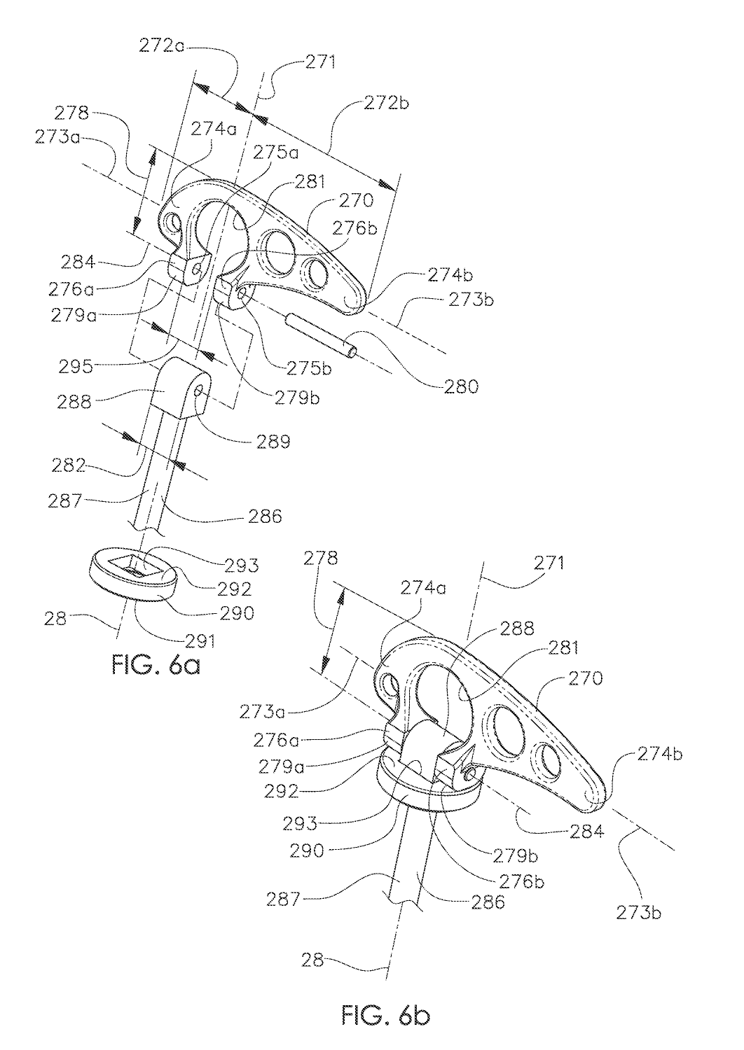

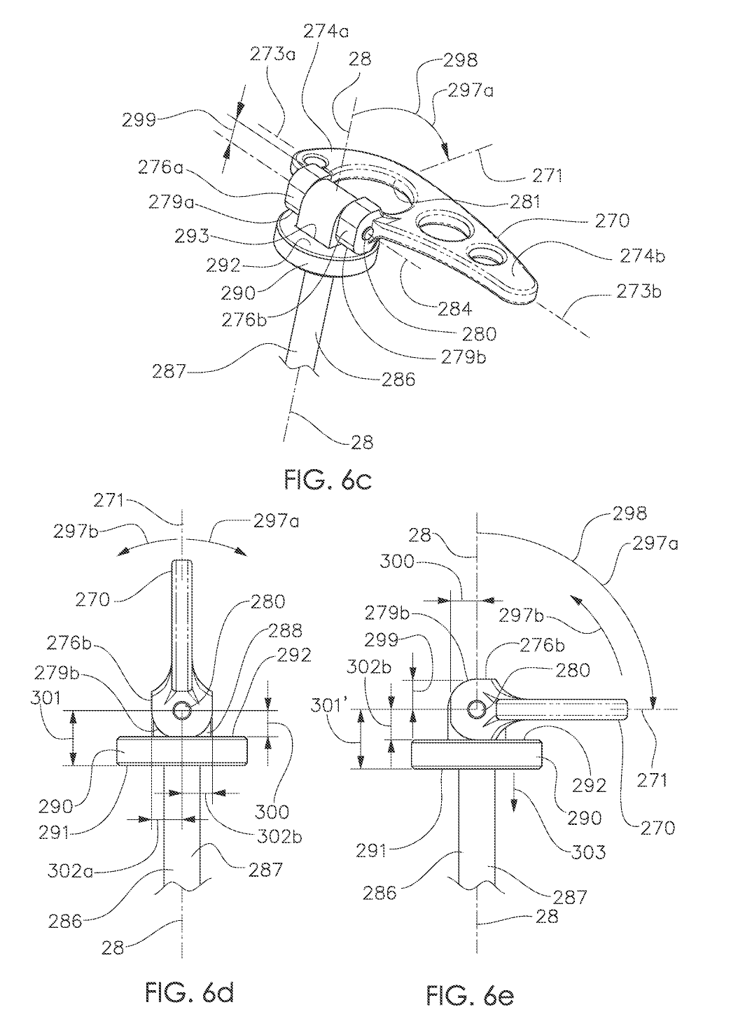

FIGS. 6a-e describes a handle embodiment similar to the embodiment of FIG. 4a-e, however this embodiment shows a cam incorporated into the hinge knuckle to provide axial clamping of the grip washer in a cam action similar to a conventional quick release skewer (as shown in FIGS. 5a-c.

FIG. 6a describes the assembly of the handle 270 with the head portion 288, including pivot pin 280 and grip washer 290. FIG. 6a is an exploded view that shows how the handle 270 is assembled to the head portion 288 by means of pivot pin 280. The handle 270 includes a handle axis 271 with lever portions 274a and 274b having arm lengths 272a and 227b respectively and lever axis 273a and 273b respectively. Handle 270 also includes looped opening 281 sized to comfortably receive the operator's finger therethrough. Pivot tabs 279a and 279b include coaxial holes 275a and 275b respectively to receive pivot pin 280 and serve as a hinge knuckles with space 295 therebetween sized to receive the width 282 of head portion 288 of the control shaft 286. Pivot tabs 279a and 279b also include cam surfaces 276a and 276b respectively to interface with the follower surface 292 of the grip washer 290. It is noted that handle axis 271 is generally perpendicular to lever axis 273a and 273b, while lever axis 273a and 273b are generally parallel to pivot axis 84. Control shaft 286 includes shank portion 287 and an enlarged head portion 288 that serves as a hinge knuckle, with hole 289 therethrough to receive the pivot pin 280. Grip washer 290 includes a grip face 291, follower face 292, and a square opening 293 therein to receive head portion 288 therethrough for a rotationally keyed engagement with the head portion 288 about the axial axis.

FIG. 6b shows the handle 270 and pivot pin 280 next assembled to the head portion 288 to create a hinged connection between the handle 280 and the head portion 288, where the handle 280 may be folded or pivoted about pivot axis 284. The handle 280 is shown in the open and extended position, where lever portions 274a and 274b are optimally aligned to be manually manipulated by the operator's fingers, with the handle axis 271 generally parallel to the axial axis 28. The handle 280 extends axially outboard of the pivot axis 284 by axial distance 278. Grip washer 290 is shown to be assembled such that opening 293 is axially overlapping head portion 288 such that it is rotationally keyed to head portion 288 and such that follower surface 292 is axially abutting cam surfaces 279a and 279b. As shown in FIG. 6b, the handle 270 may be manually manipulated to apply torque to the control shaft 286 and to control the axial position of the control shaft 286 in a manner similar to that described in FIGS. 2a-m, 3a-c, and FIGS. 4a-e. While the operator may control the axial displacement of the control shaft 286 by hooking their fingers under lever portions 274a and 274b, looped opening 281 is also provided to permit the operator to alternatively hook their finger therethrough to provide a similar functionality and control.

FIG. 6c shows the handle 270 as next folded and pivoted in direction 297 about pivot axis 284 by angle 298 (shown to be approximately 90 degrees) to a first folded or closed position. The handle axis 271 is now generally perpendicular to the axial axis 28 and the handle 270 now extends axially outboard of the pivot axis 284 by axial distance 299, which is reduced relative to the axial distance 278 associated with the open position of the lever 270. Follower face 292 is still abutting cam surfaces 279a and 279b.

FIG. 6d corresponds to the arrangement described in FIG. 6b and details the interaction between cam surfaces 279a and 279b and the follower face 292 of the grip washer 290. Cam surfaces 279a and 279b (not shown) have a reduced cam radius 300 that contacts the follower surface 292, resulting in an axial distance 301 between the pivot axis 284 and the grip face 291. Cam surfaces 279a and 279b (not shown) also have increased cam radii 302a and 302b that are not in contact with the follower surface 292.

FIG. 6e corresponds to the arrangement described in FIG. 6c where the handle has been pivoted in direction 297a to a first folded or closed position. Cam surfaces 279a and 279b (not shown) have an increased cam radius 302b that contacts the follower surface 292, resulting in an increased axial distance 301′ (as compared to distance 301 in FIG. 6d) between the pivot axis 284 and the grip face 291. The reduced cam radii 300 are no longer in contact with the follower surface 292. The action of manually pivoting the lever 270 about pivot pin 280 serves to re-orient the cam surfaces 276a and 276b with respect to follower surface 292 and to drive the grip washer 290 in the axially inward direction 303. Cam radii 302a and 302b are shown here to be identical. As such, the operator may alternatively opt to pivot the handle 270 in direction 297b to a second folded or closed position (not shown), opposed to the first folded position, such that increased cam radius 302a contacts the follower surface 292, resulting in a similarly increased axial distance (as compared to FIG. 6d) between the pivot axis 284 and the grip face 291. This gives the operator two different folding options such that the folded handle 270 may be optimally aligned for clearance with other components of the bicycle or for other function. In either case, manually pivoting the handle 270 from the open position to the closed position serves to drive the grip washer 290 in direction 303, in a cam action very similar to that of a conventional quick release skewer, such that the grip face may be pressed against the outboard face 40b of the dropout (not shown) for additional clamping and sandwiching of the dropout 32b in a manner similar to a conventional quick release skewer assembly. Additionally or alternatively, with the grip face 291 contacting the outboard face 40b in the engaged position, the rotationally keyed engagement between the head portion 288 and the grip washer 290 may serve to restrict rotation of the control shaft 286 relative to the dropout 32b to prevent the control shaft from threadably loosening relative to the dropout 32a (not shown). This further insures that the hub assembly 30 (not shown) remains firmly secured and assembled to the dropouts 32a and 32b (in an orientation corresponding to that described in FIGS. 2i and 2f).

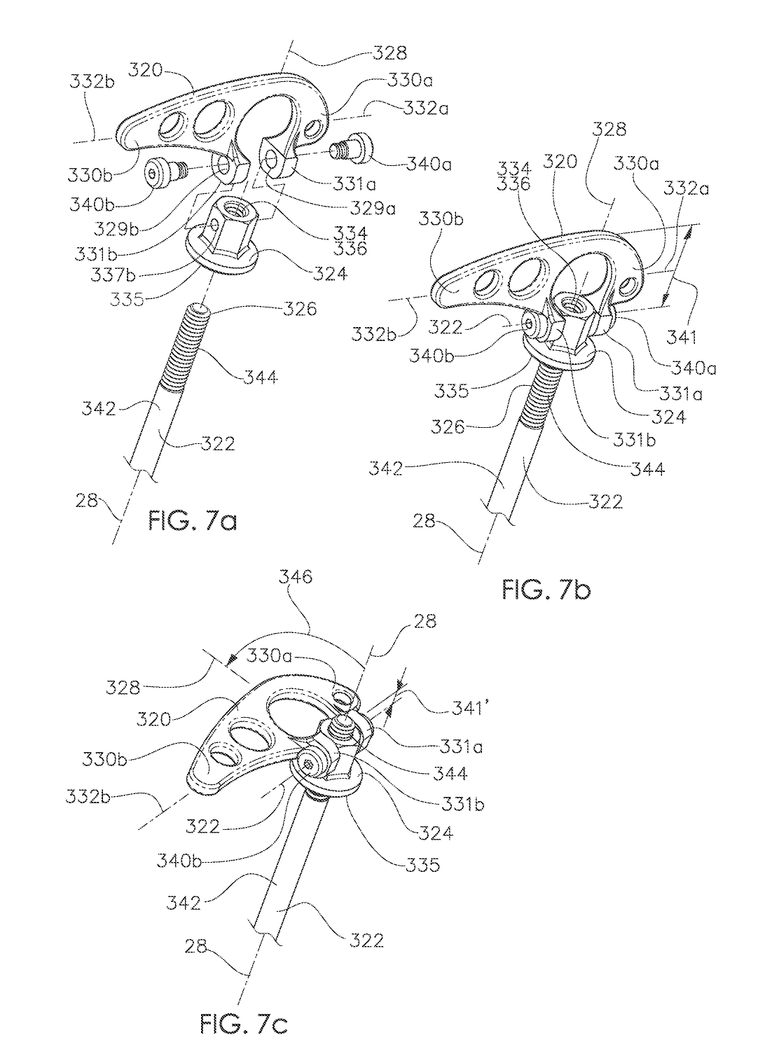

The embodiment of FIGS. 7a-c is similar to the embodiment of FIGS. 6a-e except that the handle 320 does not have a variable cam profile and the handle 320 is pivotally fixed to an internally threaded nut 324 that is threadably connected with a control shaft 322 adjacent the handle end 326. FIG. 7a is an exploded view that shows how the handle 320 is assembled to the nut 324 by means of shoulder screws 340a and 340b. The nut 324 is threadably engaged to the control shaft 322. The handle 320 includes a handle axis 328 with lever portions 330a and 330b and lever axis 332a and 332b respectively. Pivot tabs 331a and 331b include holes 329a and 329b respectively to receive shoulder screws 340a and 340b respectively and serve as a hinge knuckles with gap therebetween sized to receive the nut 324. It is noted that handle axis 328 is generally perpendicular to lever axis 332a and 332b, while lever axis 332a and 332b are generally parallel to pivot axis 322. Nut 324 includes grip face 335, hole 334 with internal threads 336 therein, and internally threaded cross holes 337a (obscured) and 337b to receive shoulder screws 340a and 340b respectively. Control shaft 322 includes shank portion 342 and external threads 344 adjacent end portion 326.

As shown in FIG. 7b, the handle 320 is assembled to nut 324 by means of shoulder screws 340a and 340b that extend through holes 329a and 329b respectively and are threadably assembled to cross holes 337a (obscured) and 337b respectively. Handle 320 may thus be pivoted about shoulder screws 340a and 340b and pivot axis 322 relative to nut 324. Internal threads 336 are threadably assembled to external threads 344 such that the axial position of end face 335 is axially adjustable by means of adjustment of this threaded engagement. Thus, grip face 335 may serve a similar function to grip face 73 (of FIGS. 2a-m) and the threaded engagement between internal threads 336 and external threads 344 may serve to advance end face 335 axially inwardly to contact and grip the dropout 32b (not shown). FIG. 7b shows the handle 320 in the open position with the handle axis 328 generally parallel to the axial axis 28, with the handle projecting axially from the pivot axis 322 by distance 341. Next, the handle 320 may be pivotally folded about pivot axis 322 in direction 346 to a closed position, with the handle projecting axially from the pivot axis 322 by distance 341′, which is significantly reduced in comparison to distance 341, thus providing a compact and low-profile arrangement for enhanced aesthetics and aerodynamics.

While my above description contains many specificities, these should not be construed as limitations on the scope of the invention, but rather as exemplifications of embodiments thereof. For example:

While the embodiments of FIGS. 2a-m, 3a-c, 6a-e and 7a-c show the lever portions as having a relatively flat contour, this is merely a schematic representation. These lever portions may alternatively have any contour deemed beneficial, including a curved or bent contour and/or a contour of variable thickness.

While the embodiments of FIGS. 2a-m show the lever portions 45a and 45b as radially opposed to each other by 180 degrees in a generally continuous plane, these lever portions may alternatively be radially and/or axially offset from each other. Further, these lever portions may be formed at an angle other than 180 degrees from each other to create a bent or curved contour.

While the lever portions 45a and 45b of FIGS. 2a-m have arm lengths 245a and 245b that are nearly equal to each other, it is noted that FIGS. 6a-e show lever portion 274a as having an arm length 272a that is somewhat shorter than arm length 272b of lever portion 274b. It is envisioned that the handle may be of any arm length that is beneficial. It is further envisioned that paired arm lengths may have any length ratio that is beneficial. Still further, it is envisioned that the handle may alternatively include only a single lever portion that extends in only one radial direction from the axial axis, without a coupled lever portion.

While the embodiments of FIGS. 2a-m, 3a-c, 6a-e and 7a-c show the handle as having two opposed lever portions, this is but a representative arrangement and it is envisioned that the handle may alternatively include and number of lever portions. For example, the handle may include only a single lever portion that extends in only one radial direction from the axial axis, without a coupled lever portion. In other examples, the handle may include three or four or more lever portions. In yet another example, the handle may include a knob-type counter, without discernible individual lever portions.

The embodiments of FIGS. 2a-m, 3a-c, 6a-e and 7a-c show the handle as serving to control a threadable engagement (for example, between external threads 62 and internal threads 107), which involves rotation (about the axial axis) and displacement (along the axial axis). This threadable engagement is merely a representative type of engagement that is commonly utilized. It is envisioned that some other type of alternate engagement may be substituted for the threadable engagement, such as a bayonet engagement or a quarter-turn engagement (akin to a Dzus® fastener).

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications that are within its spirit and scope as defined by the claims.

What is claimed is:

1. A vehicle wheel axle assembly, comprising:
an axle element that is rotationally stationary about an axial axis;
a handle connected to said axle element that may be pivotally articulated relative to said axle element about a pivot axis and between an open position and a closed position;
a frame element, including a first frame member to interface with said axle assembly;
wherein said handle includes a handle axis extending along said handle in a direction generally perpendicular to said pivot axis, a radially projecting lever portion, and a lever axis extending radially outwardly from said pivot axis and along said lever portion;
wherein said pivot axis is generally parallel to said lever axis;
wherein said axle assembly is secured to said first frame member by means of a threadable engagement; and
wherein, with said handle in said open position, said axle element may be manually manipulated by means of said handle to threadably adjust said threadable engagement.

2. An axle assembly according to claim 1, wherein, in said open position, said handle projects further radially outwardly relative to said closed position.

3. An axle assembly according to claim 1, wherein said handle includes a cam element of variable radius relative to said pivot axis, and including follower element, such that, when said handle is pivoted between said open position and said closed position, said follower element is displaced by said cam element in an axially inward direction.

4. An axle assembly according to claim 1, wherein said axle assembly includes an outer axle sleeve with an axially extending opening therethrough, and wherein said axle element is a control shaft that extends coaxially through said opening.

5. A vehicle wheel hub assembly according to claim 4, wherein said control shaft is piloted within said opening of said axle element for radial location control between said control shaft and said axle element.

6. An axle assembly according to claim 1, wherein said threadable engagement is between external threads of said control shaft and internal threads axially and circumferentially fixed to said frame element.

7. An axle assembly according to claim 1, wherein said axle assembly includes a shaft portion and wherein said axle element is a nut, and wherein said threadable engagement is between external threads of said shaft portion and internal threads of said nut.

8. A vehicle wheel hub assembly according to claim 1, wherein said axle element includes an axially inwardly facing grip face and wherein said grip face serves to axially clamp said axle assembly to said first frame element.

9. Wherein said grip face serves to provide an axially inward limit stop to said threadable adjustment of said threadable engagement.

10. A vehicle wheel hub assembly according to claim 1, wherein said axle element is positively retained to said axle assembly to restrict separation between said axle element and said axle assembly.

11. An axle assembly according to claim 1, wherein said axle element is axially biased relative to said axle assembly.

12. An axle assembly according to claim 1, wherein said handle includes a multiplicity of said lever portions.

13. An axle assembly according to claim 12, wherein said handle includes a first lever portion and a second lever portion, wherein said first lever portion is generally radially opposed of said second lever portion.

14. An axle assembly according to claim 1, wherein said handle includes a radially extending hook portion such that said hook portion may be manually hooked to facilitate the axial displacement of said handle.

15. An axle assembly according to claim 1, wherein said handle includes a loop portion with a loop opening therein such that said loop portion may be manually hooked to facilitate the axial displacement of said handle.

16. An axle assembly according to claim 1, wherein said handle may be pivotally articulated relative to said axle element between said open position and a first closed position and between said open position and a second closed position.

17. An axle assembly according to claim 16, wherein said handle axis is generally parallel to said axial axis in said open position and wherein the handle axis of said first closed position is generally radially opposed to the handle axis in said second closed position.

18. An axle assembly according to claim 16, wherein said handle includes a cam element of variable radius relative to said pivot axis, and including follower element, such that, when said handle is in said open position, said follower element is in a first axial position, and when said handle is pivoted to said first closed position, said follower element is displaced by said cam element into a second axial position axially inward of said first axial position and when said handle is pivoted to said second closed position, said follower element is pressed by said cam element into a third axial position.

19. An axle assembly according to claim 18, wherein said second axial position is equal to said third axial position.
